(19) United States
(12) Patent Application Publication
(10) Pub. No.: US 2008/0245895 A1
(43) Pub. Date: Oct. 9, 2008

(54) Gas Ejection Device and Spraying Device

(76) Inventor: Noriaki Kumono, Tokyo (JP)

Correspondence Address: HAVERSTOCK & OWENS LLP, 162 N WOLFE ROAD, SUNNYVALE, CA, 94086, US

(21) Appl. No.: 10/586,764

(22) PCT Filed: Feb. 4, 2005
(86) PCT No.: PCT/JP2005/001716

§ 371 Date: Jun. 23, 2008

(30) Foreign Application Priority Data
Feb. 4, 2004 (JP) 2004-028607
Nov. 24, 2004 (JP) 2004-339324
Nov. 24, 2004 (JP) 2004-339325

(51) Int. Cl. A62C 13/62

(52) U.S. Cl. 239/302

(57) ABSTRACT

A gas ejection device includes a bottle (5) having an opening part (13) closed by a lid (14), a needle (6) intruded into a pierced hole (14a) formed in the lid (14) for stopping up the lid. The gas ejection device also includes a holder (7) holding the needle (6) at its one end in a facing relation to the lid (14) of the bottle (5) and movable towards and away from the lid (14). The gas ejection device also includes a biasing member (8) for biasing the holder (7) towards the lid (14) of the bottle (5), and an actuating member (9) for actuating the holder (7) in a direction away from the lid (14) to extract the needle (6) from the pierced hole (14) to open the bottle (5). The gas ejection device also includes a housing (10) for accommodating the bottle (5) and the bolder (7). The bottle has been charged with a compressed gas in advance. The housing includes a gas duct (11) for forwarding the compressed gas, ejected via the pierced hole (14a) in the lid (14), to outside.

### TECHNICAL FIELD

This invention relates to a gas ejection device for ejecting compressed gas charged into a gas bottle, and to a spraying device for spraying a liquid as mist, with the use of a gas bottle exchangeably formed as a cartridge.

This application claims priority based on Japanese Patent Application No. 2004-28607, filed in Japan on Feb. 4, 2004, and on Japanese Patent Applications Nos. 2004-339324 and 2004-339325, both filed in Japan on Nov. 24, 2004. The contents of these Patent Applications are incorporated by reference into this application.

### BACKGROUND ART

A dust blower for blowing off dust and dirt affixed to precision instruments or to negative photographic films has so far been used extensively. The dust blower of this type is usually formed as a spray can into which a liquefied gas as propellant is charged under elevated pressures. On the top of the spray can, there is formed a nozzle, operating for opening/closing a valve, and also operating as an ejection button. To one end of the nozzle is connected a blow-out tube for ejecting the gas to small-sized or intricate details of target articles. On actuating the ejection button, the liquefied gas is vaporized in the can and ejected via a tube, connected to the nozzle, under the pressure generated at such time.

As a liquefied gas, used as a propellant for target components, HFC (hydrofluorocarbon) 134a or HFC152a is used extensively as substitute for Freon gas. This gas is preserved in a liquid state in a spray can under elevated pressures.

However, this HFC, if released to atmospheric air, produces a greenhouse effect. For this reason, this gas was named a greenhouse effect gas, the emission of which is to be controlled, in the Kyoto Protocol to the United Nations Framework Convention on Climate Change. In addition, attempts in reducing the emission of the gas are now being made comprehensively by industrial circles. For example, the greenhouse effect of HFC134a is 1300 times as high as that of carbon dioxide. Hence, it has been desired to change over to use of products employing compressed gas other than the HFC product.

Meanwhile, as a spraying device, ejecting the liquid in a mist, an aerosol can, in which both liquid and a liquefied carbonic acid gas have been sealed in a bottle, is now in use. With this sort of the aerosol can, a conduit flown through by the liquefied carbonic acid gas and the liquid is provided in the bottle for extending from the bottom to an ejection nozzle provided in an upper part of the bottle. The liquid rises in the conduit, under the pressure generated when the liquefied carbonic acid gas is vaporized. The liquid is ultimately sprayed in a mist via a nozzle along with the liquefied gas.

With the use of the aerosol can, the compressed gas may be sprayed extremely readily. However, since the liquefied gas is charged under elevated pressures, a complex mechanism is needed for ejection control for the compressed gas.

There is also a spraying device in which a small-sized gas bottle, exchangeably formed as a cartridge, is mounted on a cartridge adapter provided on a liquid tank charged with the liquid to be sprayed. In this sort of the spraying device, a conduit, flown through by a liquid, is provided for extending from the bottom of a tank charged with the liquid as far as the upper part of the tank. An ejection nozzle for ejecting the gas charged in the gas bottle is provided facing the vicinity of the foremost portion of the conduit. When the compressed gas is sprayed from the ejection nozzle onto the distal end of the conduit, the negative pressure prevails in the conduit. Hence, the liquid rises in the conduit and sprayed in a mist by the gas blown from the ejection nozzle. When the inside of the bottle has become depleted of the gas, the gas bottle is dismounted from the cartridge adapter and an unused gas bottle is mounted in position, so that the bottle may be used on end.

In the spraying device in which the liquefied gas and the liquid are charged in the bottle, the liquid can be sprayed extremely readily. However, if liquefied gas or the liquid has been used up, the device can no longer be used and has to be discarded as a waste.

On the other hand, in a spraying device employing a gas bottle formed exchangeably as a cartridge, the gas bottle is handled by itself. Hence, the opening part is closed before use and, when the device is mounted on e.g. a cartridge, the opening part is opened using an opener needle. Thus, if once the gas bottle is mounted on a cartridge adapter, it cannot be dismounted until the gas charged has been used up. If the gas bottle is inadvertently detached from the cartridge adapter, the gas may be ejected at a time from the opening part under elevated pressure, or the bottle may be popped out, thus presenting an extremely dangerous state. Moreover, if the user's finger touches the opened opening part, there is a risk of frost injury otherwise caused by the heat of vaporization of the liquefied carbonic acid gas contained into the bottle.

Moreover, if the gas bottle, once mounted on the cartridge adapter, is dismounted therefrom, the carbonic acid gas charged is ejected in its entirety, so that it is not possible to re-use the residual carbonic acid gas.

Furthermore, if, even before mounting the gas bottle to the cartridge adapter, the gas bottle is inadvertently dropped and the opening part is thereby injured, there is risk that the carbonic acid gas charged is ejected from the opening part, so that thee is a danger of the bottle popping out or the frost injury to a user. Besides, the gas bottle can no longer be put to re-use.
Patent Publication 1: JP Laid-Open Patent Publication 2003-146393

### DISCLOSURE OF THE INVENTION

### Problems to be solved by the Invention

It is therefore an object of the present invention to provide a gas ejection device in which ejection control of the compressed gas is performed with the use of a small-sized gas bottle charged with the compressed gas, whereby the ejection control of the compressed gas may be implemented by a simplified structure.

It is another object of the present invention to provide a spraying device employing a gas bottle cartridge exchangeably constructed as a cartridge which may be dismounted in safety for re-use even after the cartridge is mounted once on the spraying device.

### Means to solve the problem

For accomplishing the above objects, the present invention provides a gas ejection device comprising a bottle having an opening part closed by a lid, with the bottle being charged with a compressed gas in advance, a needle piercing through a pierced hole formed in the lid for stopping up the lid, a holder holding the needle at one end thereof in a facing relation to the lid of the bottle and movable towards and away from the lid, a biasing member for biasing the holder towards the lid of the bottle, an actuating member for actuating the holder in a direction away from the lid to extract the needle from the pierced hole for opening the bottle, and a housing for accommodating the bottle and the holder therein. The housing includes a gas duct for forwarding the compressed gas, ejected via the pierced hole in the lid, to outside.

In the gas ejection device of the present invention, the carbonic acid gas, which is not liable to produce the greenhouse effect, is used as a compressed gas form the perspective of suppressing the greenhouse effect.

The present invention also provides a spraying device comprising a gas bottle cartridge, and a liquid tank. The gas bottle cartridge includes a bottle having an opening part closed by a lid, a needle piercing through a pierced hole formed in the lid for stopping up the lid, a holder holding the needle at one end thereof in a facing relation to the lid of the bottle and movable towards and away from the lid, a biasing member for biasing the holder towards the lid of the bottle, an actuating member for actuating the holder in a direction away from the lid for opening the bottle, and a housing for accommodating the bottle and the holder therein. The bottle is charged with a compressed gas in advance, The housing includes a mating coupling part formed with a gas duct for forwarding the compressed gas, ejected via the pierced hole in the lid, to outside. The liquid tank includes a tank part charged with liquid, a liquid tube for forwarding the liquid charged in the tank part to outside the tank part, a coupling part for being coupled to the mating coupling part in the housing for coupling detachably to the gas cartridge bottle, and a nozzle member passed through the coupling part so that a distal end thereof faces the vicinity of an ejection port of the liquid tube. The liquid is ejected in a mist along with the compressed gas.

The present invention also provides a spraying device comprising a tank part charged with a liquid in advance, a liquid tube for forwarding the liquid charged into the tank part to outside the tank part, an ejection unit communicating with the liquid tube for discharging the liquid flowing in the liquid tube, a bottle having an opening part sealed by a lid and charged in advance with a compressed gas, a needle piercing through a pierced hole formed in the lid for stopping the pierced hole, a holder for holding the needle in a facing relation to the lid of the bottle for movement towards and away from the lid, a biasing member for biasing the holder towards the lid of the bottle, an actuating member for actuating the holder in a direction away from the lid for opening the bottle, and an enclosure including a gas duct for the compressed gas. The gas duct includes an ejection port of the compressed gas, ejected from the pierced hole in the bottle, with -the ejection port facing the vicinity of the ejection part of the liquid. The enclosure houses the bottle and the holder. The liquid is ejected in a mist along with the compressed gas.

### Effect of the Invention

In the above gas ejection device, when the compressed gas has been charged into a bottle formed by a metal enclosure and no compressed gas is being sprayed, the holder is biased towards the bottle, with the acute end of the needle closing the lid of the bottle to inhibit ejection of the compressed gas. Thus, with the gas ejection device, the ejection control of the compressed gas may be performed by a simplified configuration of intruding/extracting the needle for the lid.

Moreover, in the above spraying device, the holder is biased towards the bottle, in a state where no liquid is being sprayed, with the holder being then biased towards the bottle to stop up the lid of the bottle with the needle to inhibit ejection of the compressed gas. Hence, with the spraying device, the gas bottle cartridge may be dismounted in safety from the liquid tank, even after assembling the gas bottle cartridge and the liquid tank together, without the risk of ejection of the compressed gas or the frost injury otherwise caused by the heat of vaporization.

In addition, in the above spraying device, the bottle may be mounted to the liquid tank currently used, or to another liquid tank, even if compressed gas is left in the bottle, for re-using the bottle.

Furthermore, in the above spraying device, in which the lid has been pierced by the needle and thereby closed, by the holder being biased towards the bottle by the biasing member, there is no risk of ejection of compressed gas accommodated in the bottle, or the risk of frost injury otherwise caused by the heat of vaporization, even if the gas bottle cartridge has been dropped inadvertently before mounting the gas bottle cartridge to the coupling part of the liquid tank, thus assuring safe handling.

In the above spraying device, when the compressed gas has been charged into the tank, and no compressed gas is being sprayed, the holder is biased towards the bottle, and the acute end of the needle closes the lid of the bottle to inhibit ejection of the compressed gas. Thus, ejection control of the compressed gas may be carried out by a simplified configuration consisting in inserting and extracting the needle with respect to the lid.

### BRIEF DESCRIPTION OF THE DRAWINGS

FIG. 1 is a perspective view showing a gas ejection device according to an embodiment of the present invention.

FIG. 2 is an exploded perspective view showing the gas ejection device according to an embodiment of the present invention.

FIG. 3 is a cross-sectional view of the gas ejection device according to an embodiment of the present invention.

FIG. 4 is a cross-sectional view of the gas ejection device according to an embodiment of the present invention, when looking from the upper surface of the device.

FIG. 5 is a perspective view showing the inside of the gas ejection device with the gas ejection in cessation.

FIG. 6 is a perspective view showing the inside of the gas ejection device with the gas being ejected.

FIG. 7 is a perspective view showing a gas ejection device according to a modification of the present invention.

FIG. 8 is an exploded perspective view of the gas ejection device according to the modification of the present invention.

FIG. 9 shows a lever member used in the gas ejection device according to the modification of the present invention.

FIG. 10 is a perspective view for illustrating the method for assembling the gas ejection device according to the modification of the present invention.

FIG. 11 is similarly a perspective view for illustrating the method for assembling the gas ejection device according to the modification of the present invention.

FIGS. 12(A) and 12(B) are perspective views of a spraying device according to an embodiment of the present invention, where FIG. 12(A) shows the state in which the gas bottle cartridge has been dismounted from the liquid tank, and FIG. 12(B) shows the state in which the gas bottle cartridge has been mounted on the liquid tank.

FIG. 13 is an exploded perspective view of a spraying device embodying the present invention.

FIG. 14 is a cross-sectional view showing the spraying device with the liquid tank and the gas bottle cartridge detached from each other.

FIG. 15 is a cross-sectional view showing the spraying device with the liquid tank and the gas bottle cartridge coupled to each other.

FIG. 16 is a perspective view showing a modification of the spraying device embodying the present invention.

FIG. 17 is an exploded perspective view of a gas bottle cartridge of a modification of the spraying device embodying the present invention.

FIG. 18 is a perspective view showing a gas bottle cartridge of a modification of the spraying device embodying the present invention.

FIG. 19 is a perspective view showing a gas bottle cartridge of a modification of the spraying device embodying the present invention.

### BEST MODE FOR CARRYING OUT THE INVENTION

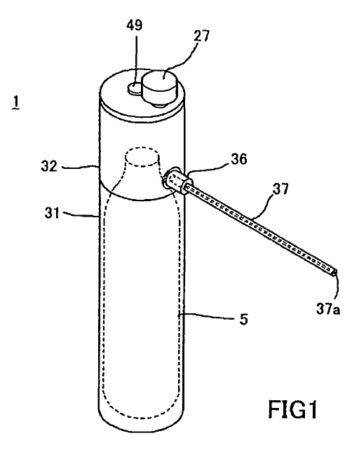

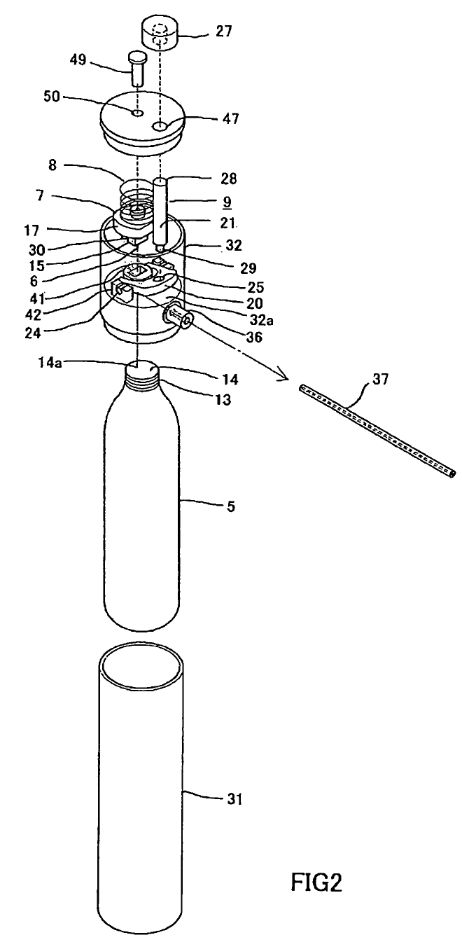

A gas ejection device and a spraying device according to the present invention will now be described with reference to the drawings. Initially, the gas ejection device will be described and the spraying device will then be described. A gas ejection device 1 is used as a dust blower for removing dust and dirt when fabricating and fixing precision instruments or when handling a semiconductor device or a negative photographic film, by way of an example. Referring to FIGS. 1 and 2, the gas ejection device includes a carbonic acid gas cartridge bottle 5, charged with a carbonic acid gas, as compressed gas, and a holder 7 for holding an acute-pointed member, such as a needle 6, for opening/closing the carbonic acid gas cartridge bottle 5. The gas ejection device also includes a torsion coil spring 8 for biasing the holder 7 towards an opening of the carbonic acid gas cartridge bottle 5, and an actuating member 9 for actuating the holder 7 in a direction away from the opening of the carbonic acid gas cartridge bottle 5 for releasing the carbonic acid gas. The gas ejection device also includes a housing 10 in which there are accommodated the carbonic acid gas cartridge bottle 5 and the holder 7 and which has a gas duct 11 for forwarding the carbonic acid gas, ejected from the carbonic acid gas cartridge bottle 5, to outside the device.

The liquefied carbonic acid gas has been charged in a substantially cylindrical metal enclosure of the carbonic acid gas cartridge bottle 5. An opening part 13 is formed in one end of the metal enclosure of the carbonic acid gas cartridge bottle 5. The opening part 13 is covered by a lid 14 to prevent the carbonic acid gas from leaking outwards from the inside of the metal enclosure. A pierced hole 14a is formed in the lid 14 by the needle 6 held by the holder 7 as later explained. The opening part 13 is stopped up by the needle 6 piercing through the pierced hole 14a.

With the above-described carbonic acid gas cartridge bottle 5, the carbonic acid gas is ejected through the pierced hole 14a of the lid 14 by uplifting the needle 6 which has passed through the lid 14. Moreover, with the above-described carbonic acid gas cartridge bottle 5, the opening part 13 is stopped up by the needle 6 passed through the pierced hole 14a to prevent ejection of the carbonic acid gas.

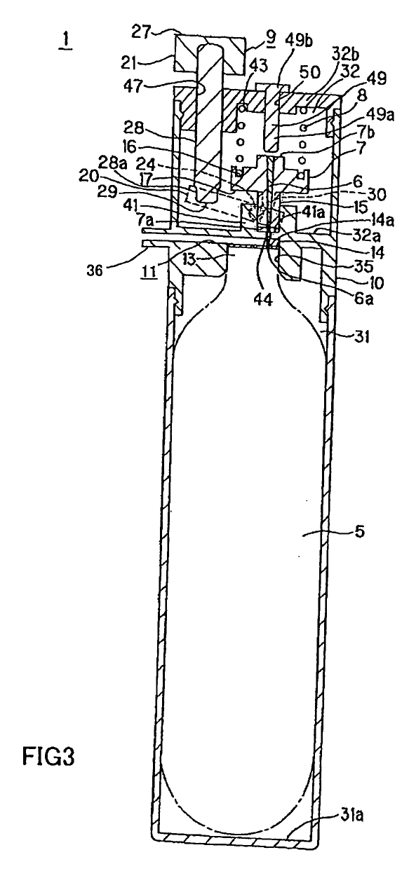

Referring to FIG. 3, the holder 7, adapted for holding the needle 6 and for opening/closing the carbonic acid gas cartridge bottle 5, is formed to a substantially convexed cross-section, and is made up by a protuberant part 15 and a flange part 17. The needle 6, piercing through the lid 14 of the carbonic acid gas cartridge bottle 5, is passed through and retained by the protuberant part 15. The torsion coil spring 8, biasing the holder 7 towards the carbonic acid gas cartridge bottle 5, is retained by a retention groove 16 formed in the flange part 17.

The protuberant part 15, through which the needle 6 is introduced and retained, is slidably carried by a guide wall section 41, formed as one with the housing 10 as later explained. The holder 7 is acted on by the actuating member 9, as later explained, and is thereby moved in a direction in which the protuberant part 15 is moved in a direction away from the carbonic acid gas cartridge bottle 5 against the force of the torsion coil spring 8.

The needle 6, adapted for stopping up the lid 14 of the carbonic acid gas cartridge bottle 5, has an acute end 6a protruded from a bottom surface 7a of the holder 7 and pierced through the lid 14 of the carbonic acid gas cartridge bottle 5. That is, the needle 6 forms the pierced hole 14a in the lid 14, while also closing this pierced hole 14a to prevent the carbonic acid gas from flowing outwards from within the carbonic acid gas cartridge bottle 5, into which the gas has been charged in advance.

The flange part 17, forming the end of the holder 7 opposite to the carbonic acid gas cartridge bottle 5, is engaged by the torsion coil spring 8, such as a compression spring, adapted for biasing the holder 7. When the holder 7 is housed within the housing 10, as later explained, as the torsion coil spring 8 is engaged with the holder, the torsion coil spring 8 has one end abutted against the inner wall section of the housing 10, while having the opposite end retained by the retention groove 16 of the flange part 17. Thus, the torsion coil spring 8 biases the holder 7 towards the lid 14 of the carbonic acid gas cartridge bottle 5.

When the holder 7, arranged and constructed as described above, is housed within the housing 10, the lid 14 of the carbonic acid gas cartridge bottle 5 faces the bottom surface 7a carrying the needle 6. Since the holder 7 is biased by the torsion coil spring 8 towards the carbonic acid gas cartridge bottle 5, the needle 6 forms the pierced hole 14a through the lid 14, while the acute end 6a thereof is passed through the pierced hole 14a for stopping up the carbonic acid gas cartridge bottle 5.

When the holder 7 is moved by the actuating member 9 in a direction away from the carbonic acid gas cartridge bottle 5, against the force of the torsion coil spring 8, the acute end 6a of the needle 6 is uplifted, away from the lid 14, to enable the carbonic acid gas to be ejected outwards. The so ejected carbonic acid gas flows through the gas duct 11 of the housing 10 so as to be ejected outwards. When the force of actuation of the actuating member 9 is removed, the holder 7 is biased towards the carbonic acid gas cartridge bottle 5, under the force of the torsion coil spring 8. The acute end 6a of the needle 6 is passed through the pierced hole 14a formed in the lid 14 of the carbonic acid gas cartridge bottle 5 to terminate the ejection of the carbonic acid gas.

The torsion coil spring 8, biasing the holder 7 towards the carbonic acid gas cartridge bottle 5, biases the holder 7 with a pressure greater than the pressure with which the acute end 6a of the needle 6, introduced into the inside of the carbonic acid gas cartridge bottle 5 via pierced hole 14a of the lid 14, is pressured by the carbonic acid gas charged into the cartridge bottle. That is, the needle 6, retained by the holder 7, is not pressed out of the pierced hole 14a, under the gas pressure in the cartridge bottle, even when the needle has been passed through the pierced hole 14a of the lid 14 so as to be protruded into the inside of the carbonic acid gas cartridge bottle 5. Thus, with the gas ejection device 1, it is possible to prevent leakage of the carbonic acid gas, charged into the carbonic acid gas cartridge bottle 5, from the inside of the carbonic acid gas cartridge bottle, before actuation on the holder 7 by the actuating member 9.

The actuating member 9, adapted for acting on the holder 7 for ejecting the carbonic acid gas from within the carbonic acid gas cartridge bottle 5, includes a lever member 20 and an actuating button 21. The lever member 20 is connected to the protuberant part 15 of the holder 7 and rotationally carried by the housing 10, and the actuating button 21 is adapted for thrusting and acting on one end 20a of the lever member 20.

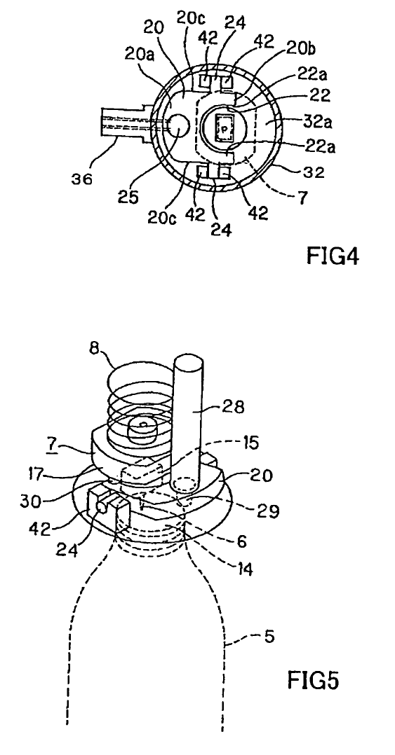

Referring to FIGS. 2 and 4, the lever member 20 is a plate-shaped member, the opposite end 20b of which is cut out at 22a to a substantially arcuate shape to conform to the shape of a wall section 41 of the housing 10. The cut-out 22 has facing sides 22a, 22a located below the flange part 17 of the holder 7. When the opposite end 20b of the lever member 20 is rotated upwards, the opposite end 20b impinges on a push-down boss 30, protuberantly formed on the flange part 17, for uplifting the holder 7. On outer lateral surfaces 20c, 20c of the lever member 20, there are protuberantly formed rotation lugs 24 carried by rotation supports 42 formed on the housing 10. The rotation lugs 24 are formed by columnar-shaped protrusions rotationally carried by recesses formed in the rotation supports 42, as later explained. Towards one end of the major surface part of the lever member 20, there is formed an engagement opening 25 engaged by one end of the actuating button 21.

The actuating button 21, engaged in the engagement opening 25 of the lever member 20, includes an operating part 27, formed on the upper surface of the housing 10 and which is thrust by a user's manual operation, and a thrust shaft 28, carried for movement in an up-and-down direction within the housing 10 and having one end 28a engaged in the engagement opening 25 of the lever member 20. The thrust shaft 28 has its opposite end 28b protruded above the upper surface of the housing 10 and connected to the operating part 27. The thrust shaft 28 is formed at its one end 28a with an engagement protrusion 29 and is connected to the lever member 20 by this engagement protrusion 29 engaging in the engagement opening 25 formed in the major surface part of the lever member 20.

The opposite end 20b of the lever member 20 with respect to the rotation lugs 24 is thrust downwards by the push-down boss 30, formed on the flange part 17 of the holder 7, biased at all times towards the carbonic acid gas cartridge bottle 5 by the torsion coil spring 8. Hence, the opposite end 20b is rotated downwards, with the rotation lugs 24 as pivot, whilst the one end 20a is rotated upwards, as shown in FIG. 3. Consequently, the actuating button 21 has its operating part 27 elevated at all times by engagement with the one end 20a of the lever member 20.

When the operating part 27 of the actuating member 9 is pushed down by the user, the one end 20a of the lever member 20, thrust by the thrust shaft 28, is rotated downwards, with the rotation lugs 24 as pivot, while its opposite end 20b is rotated upwards. Hence, the facing sides 22a, 22a, formed on the opposite end 20b of the lever member 20, acts on the lower side of the push-down boss 30 of the flange part 17, so that the holder 7 is elevated, against the bias of the torsion coil spring 8, in a direction away from the lid 14 of the carbonic acid gas cartridge bottle 5. This uplifts the acute end 6a of the needle 6, carried by the holder 7, from the lid 14 of the carbonic acid gas cartridge bottle 5, to permit ejection of the carbonic acid gas.

The housing 10, having housed therein the carbonic acid gas cartridge bottle 5 and the holder 7, is formed to a substantially tubular shape, from a thermoplastic resin, such as ABS resin, and is made up by a lower housing section 31 and an upper housing section 32. In the lower housing section and in the upper housing section, there are accommodated the carbonic acid gas cartridge bottle 5 and the holder 7, respectively. The housing 10 is of a size that permits the operation by a user with one hand. In this housing 10, the gas duct 11 for the carbonic acid gas is formed in the upper housing section 32.

The lower housing section 31 is of a height and a diameter approximately the same as those of the carbonic acid gas cartridge bottle 5, and is capable of holding the carbonic acid gas cartridge bottle 5 without idle movements.

The upper housing section 32, in which is accommodated the holder 7, is formed as one with or detachably from the lower housing section 31. The upper housing section 32 is formed with a guide wall section 41 for guiding the movement of the protuberant part 15 of the holder 7, paired rotation supports 42, 42 and a retainer 43 for retaining one end of the torsion coil spring 8. The paired rotation supports support the rotation lugs 24 of the lever member 20.

The guide wall section 41 is protuberantly formed on a lower surface section 32a of the upper housing section 32 to slidably support the protuberant part 15 of the holder 7. In a recess 41a, delimited by the guide wall section 41, and into which is introduced the protuberant part 15 of the holder 7, there is formed a through-hole 44 to be passed through by the needle 6 retained by the holder 7. This through-hole 44 is formed by the needle 6 piercing through the lower surface section 32a at the same time as the needle 6 pierces through the lid 14 of the carbonic acid gas cartridge bottle 5 at the outset. Hence, the through-hole 44 is formed to the same diameter as the diameter of the needle 6. The lower surface section 32a is formed of a lubricious and repellant material, such as polyethylene, for forwarding the movement of the needle 6. In addition, when the needle 6 is extracted from the pierced hole 14a of the lid 14, no gap is formed between the through-hole 44 and the needle 6 so that it is possible to prevent the carbonic acid gas from flowing into the upper housing section 32.

The rotation supports 42, 42 are formed for protruding from the lower surface section 32a of the upper housing section 32, and are formed with support recesses for rotationally supporting the rotation lugs 24, 24 of the lever member 20.

The retainer 43 is formed in an upper surface section 32b of the upper housing section 32 for engagement with the opposite end of the torsion coil spring 8 which has its one end retained in the retention groove 16 formed in the flange part 17 of the holder 7. This biases the holder 7 towards the carbonic acid gas cartridge bottle 5 under the force of the torsion coil spring 8.

In a lower surface side of the upper housing section 32 is formed a tapped hole 35 for threaded engagement with the vicinity of the opening part 13 of the carbonic acid gas cartridge bottle 5. Thus, when accommodated within the housing 10, the carbonic acid gas cartridge bottle 5 may have its opening part 13 carried by the tapped hole 35 and may thereby be retained in a state free from performing idle movements.

In the upper housing section 32, there is formed the gas duct 11 for forwarding the carbonic acid gas, ejected via carbonic acid gas cartridge bottle 5, to outside the gas ejection device. The gas duct 11 leads to the lid 14 of the carbonic acid gas cartridge bottle 5, accommodated in the housing 10, so that the carbonic acid gas, ejected via pierced hole 14a of the lid 14, is allowed to flow therethrough. An ejection part 36 for extending the gas duct 11 outwards for ejecting the carbonic acid gas is protuberantly formed on the upper housing section 32. To the ejection part 36 may be detachably mounted an ejection nozzle 37, as shown in FIG. 2. With the ejection nozzle 37, thus attached in place, the carbonic acid gas may vigorously be ejected to targeted locations.

In the upper surface section 32b of the upper housing section 32 is formed a through-opening 47 through which to insert the thrust shaft 28 of the actuating member 9. The through-opening 47 supports the thrust shaft 28 while guiding the thrust shaft in its movement in the up-and-down direction.

In the upper surface section 32b of the upper housing section 32 is also formed a through-opening 50 through which to insert a control member 49 for restricting the upward movement of the holder 7 to control the amount of extraction of the needle 6 from the lid 14 to control the ejection of the carbonic acid gas. The control member 49 is made up of a shaft part 49a introduced into the inside of the upper housing section 32 so as to compress against an upper surface section 7b of the holder 7, and an adjustment part 49b provided outwardly of the upper surface section 32b of the upper housing section 32 for adjusting the depth of intrusion of the shaft part 49a. The through-opening 50 is a tapped hole for engaging with a male threaded portion of the shaft part 49a of the control member 49.

By rotating the adjustment part 49b of the control member 49, provided outside of the upper surface section 32b of the upper housing section 32, the depth of intrusion of the shaft part 49a may be adjusted to adjust the position of abutment of the distal end of the shaft part 49a and hence the location of abutment of the distal end of the shaft part 49a against the upper surface section 7b of the holder 7. Thus, even in case the holder 7 has been uplifted by the actuating member 9, by turning the adjustment part 49b of the control member 49, the shaft part 49a of the control member 49 compresses against the upper surface section 7b of the holder 7 to restrict the elevation of the holder 7. Hence, the flow of the carbonic acid gas may be controlled to prevent the carbonic acid gas from being ejected in an amount more than is necessary.

The operation during actual field use of the gas ejection device 1, constructed and arranged as described above, will now be described. During actual use of the gas ejection device 1, the ejection nozzle 37 is connected to the ejection part 36, provided on the upper housing section 32 of the housing 10 so that the ejection nozzle 37 will form an extension of the gas duct 11, as shown in FIG. 1.

At this time, with the carbonic acid gas cartridge bottle 5, accommodated in the lower housing section 31 of the housing 10, the holder 7 is biased downwards by the torsion coil spring 8, as shown in FIG. 5. Thus, in the gas ejection device 1, the acute end 6a of the needle 6, held by the holder 7, pierces through the lid 14 to form a through-opening at the outset, at the same time as the acute end 6a of the needle 6 closes the pierced hole 6a to prevent ejection of the carbonic acid gas.

Since the lever member 20 of the actuating member 9 is thrust downwards by the push-down boss 30 of the holder 7, biased at all times by the torsion coil spring 8 towards the carbonic acid gas cartridge bottle 5, the opposite end 20b of the lever member is rotated downwards, with the rotation lugs 24 as pivot, while the one end 20a thereof is rotated upwards, as shown in FIG. 3. Consequently, the actuating button 21 of the actuating member 9, engaged with the one end 20a of the lever member 20, perpetually uplifts the operating part 27.

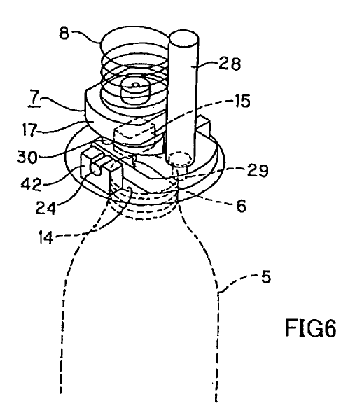

The user then holds the housing 10 of the gas ejection device 1, as he/she directs an ejection end 37a, formed at the distal end of the ejection nozzle 37, towards a target for ejection. When the user then thrusts the actuating button 21 of the actuating member 9, the one end 28a of the thrust shaft 28 is moved downwards, so that the one end 20a of the lever member 20, engaged with the thrust shaft 28, is rotated downwards, as shown in FIG. 6. The one end 20a of the lever member 20, engaged with the thrust shaft 28, is rotated downwards, about the rotation lugs 24 as pivot, while the other end 20b is rotated upwards. Since the facing sides 22a, 22a, formed at the opposite end 20b of the lever member 20, compress against the lower face of the push-down boss 30 of the flange part 17, the holder 7 is uplifted, against the bias of the torsion coil spring 8, in a direction away from the lid 14 of the carbonic acid gas cartridge bottle 5. This uplifts the acute end 6a of the needle 6, carried by the holder 7, away from the pierced hole 14a of the lid 14 of the carbonic acid gas cartridge bottle 5, thus ejecting the carbonic acid gas compressed in the bottle.

The carbonic acid gas, thus ejected, flows into the ejection nozzle 37, attached to the ejection part 36, via gas duct 11 in the lower housing section 31 of the housing 10, so as to be ejected via ejection end 37a of the ejection nozzle 37.

Meanwhile, the adjustment part 49b of the control member may be rotated to adjust the depth of intrusion of the shaft part 49a and hence the point of abutment of the distal end of the shaft part 49a against the upper surface section 7b of the holder 7 at the outset. Thus, when the holder 7 is uplifted by the actuating member 9, the shaft part 49a of the control member 49 is abutted against the upper surface section 7b of the holder 7 to control the uplifting of the holder 7, as well as to prohibit the carbonic acid gas from being ejected in an amount more than is necessary.

When the thrusting by the user on the actuating button 21 of the actuating member 9 is released, the holder 7 is biased towards the carbonic acid gas cartridge bottle 5 under the bias of the torsion coil spring 8. Hence, the acute end 6a of the needle 6, held by the holder 7, is passed through the pierced hole 14a of the lid 14 of the carbonic acid gas cartridge bottle 5, for stoppering the carbonic acid gas cartridge bottle 5. This halts the ejection of the carbonic acid gas; cartridge bottle 5 via ejection nozzle 37.

The lever member 20 has the opposite end 20b thrust by the push-down boss 30 of the holder 7, biased towards the carbonic acid gas cartridge bottle 5, so that the lever member has its one end 20a rotated upwards with the rotation lugs 24 as pivot. Thus, the thrust shaft 28 is moved upwards, so that the actuating button 21, engaged with the one end 20a of the lever member 20, and hence the operating part 27, are uplifted to above the upper surface section 32b of the upper housing section 32.

Thus, in a state of the gas ejection device 1 in which the carbonic acid gas has been charged into the carbonic acid gas cartridge bottle 5, formed by a metal enclosure, and the spraying of the carbonic acid gas is in cessation, the holder 7 is biased towards the carbonic acid gas cartridge bottle 5 and the acute end 6a of the needle 6 closes the lid 14 of the carbonic acid gas cartridge bottle 5 to prohibit the ejection of the carbonic acid gas. Hence, with the gas ejection device 1, ejection of the carbonic acid gas may be controlled reliably by a simplified configuration consisting in inserting the needle 6 into the lid 6 and withdrawing the needle 6 from the lid 14.

The gas ejection device according to the present invention may also be configured as explained below. It should be noted that, in a gas ejection device 100, explained below, the same components as those of the above-described gas ejection device 1 are depicted by the same reference numerals and detailed description therefor is dispensed with.

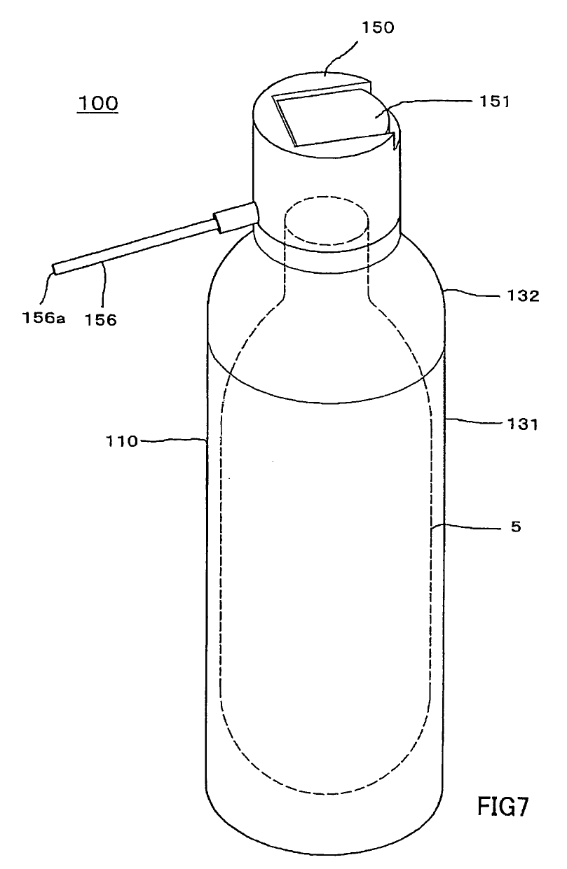

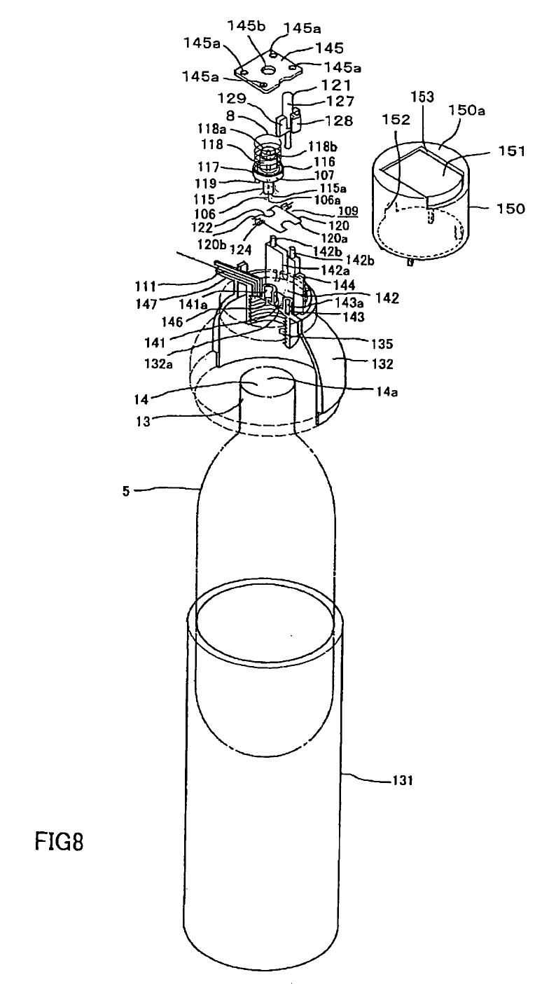

Referring to FIGS. 7 and 8, this gas ejection device 100 includes a carbonic acid gas cartridge bottle 5, charged with a carbonic acid gas, as compressed gas, and a holder 107 for holding a needle 106 adapted for opening/closing the carbonic acid gas cartridge bottle 5. The gas ejection device 100 also includes a torsion coil spring 8 for biasing the holder 107 towards an opening part side of the carbonic acid gas cartridge bottle 5, and an actuating member 109 for actuating the holder 107 in a direction away from the opening part of the carbonic acid gas cartridge bottle 5 for releasing the carbonic acid gas. The gas ejection device 100 further includes a housing 110 which has housed therein the carbonic acid gas cartridge bottle 5, a holder 107 and an actuating member 109 and which is provided with a gas duct 111 for forwarding to outside the carbonic acid gas ejected from the carbonic acid gas cartridge bottle 5.

The carbonic acid gas cartridge bottle 5 includes a metal enclosure in which has been charged the liquefied carbonic acid gas, as described above. In addition, a pierced hole is formed in the carbonic acid gas cartridge bottle by the needle 106 of the holder 107 piercing through the pierced hole 14a of the lid 14, while the carbonic acid gas is prohibited from being ejected.

Referring to FIG. 8, the holder 107, holding the needle 10-2 and adapted for opening/closing the carbonic acid gas cartridge bottle 5, includes a protuberant part 115, a flange part 117 and a torsion coil spring fitting part 118. The flange part 117 includes a retention groove 116 for retaining a torsion coil spring 8 adapted for biasing the holder 107 towards the carbonic acid gas cartridge bottle 5. On the torsion coil spring fitting part 118 is fitted the torsion coil spring 8.

The protuberant part 115, through which is passed and held the needle 106, is slidably supported by a holder guide wall section 141, formed in a housing 110, as later explained, and guides the movement of the needle in a direction towards and away from the carbonic acid gas cartridge bottle 5. In addition, the holder 107 is abutted by the actuating member 109 as later explained and thereby actuated so that the protuberant part 115 will be moved in a direction away from the carbonic acid gas cartridge bottle 5 against the bias of the carbonic acid gas cartridge bottle 5.

The needle 106, closing the lid of the carbonic acid gas cartridge bottle 5, has its acute end 106a protruded from a bottom surface section 115a of the protuberant part 115, and pierces through the lid 14 of the carbonic acid gas cartridge bottle 5. Thus, the needle 106 forms a pierced hole 14 in the lid 14, while closing this pierced hole 14a to prohibit the carbonic acid gas charged into the carbonic acid gas cartridge bottle 5.

The flange part 117, provided on an end of the holder 107 opposite to the carbonic acid gas cartridge bottle 5, is engaged by the torsion coil spring 8, such as a compression spring, adapted for biasing the holder 107. This torsion coil spring 8 is engaged around the holder 107 and, in this state, the holder 107 is housed in an upper housing section 132 of the housing 110, as later explained. The torsion coil spring 8 has one end abutted against a top plate 145 of the housing 110, while having the other end retained in the retention groove 116 of the flange part 117. Thus, the torsion coil spring 8 biases the holder 107 in a direction towards the lid 14 of the carbonic acid gas cartridge bottle 5.

The flange part 117 also includes a lug 119 abutted by a lever member 120 of the actuating member 109. The lug 119, thus abutted by the lever member 120, transmits the biasing force of the torsion coil spring 8 to the lever member 120. The lug also transmits the biasing force of the lever member 120, rotated by the actuating member 109, to the holder 107.

The torsion coil spring fitting part 118, protuberantly formed on the opposite side of the protuberant part 115, with the flange part 117 in-between, is engaged by the torsion coil spring 8 for engaging with and holding the torsion coil spring by the holder 107. The torsion coil spring fitting part 118 has a distal and 118a reduced in diameter to form a flange part 11 8b which is introduced into and retained by the top plate 145 as later explained.

When the holder 107, arranged and constructed as described above, is accommodated in the housing 110, the lid 14 of the carbonic acid gas cartridge bottle 5 faces a bottom surface section 115a of the protuberant part 115 carrying the needle 106. Since the holder 107 is biased towards the carbonic acid gas cartridge bottle 5 by the torsion coil spring 8, the needle 106 pierces through the lid 14, while the acute end 106a is passed through the pierced hole 14a for stopping up the carbonic acid gas cartridge bottle 5.

When the holder 107 is moved by the actuating member 109 in a direction opposite to the carbonic acid gas cartridge bottle 5, against the bias of the torsion coil spring 8, the acute end 106a of the needle 106 is uplifted, in a direction away from the lid 14, thus ejecting the carbonic acid gas. The carbonic acid gas, thus ejected, flows through the gas duct 111 of the housing 110 and thence ejected to outside. When freed from the biasing force, exerted by the actuating member 109, the holder 107 is biased towards the carbonic acid gas cartridge bottle 5, under the bias of the torsion coil spring 8. The acute end 106a of the needle 106 then pierces through the pierced hole 14a, formed through the lid 14 of the carbonic acid gas cartridge bottle 5, such as to stop the ejection of the carbonic acid gas.

Meanwhile, the torsion coil spring 8, biasing the holder 107 towards the carbonic acid gas cartridge bottle 5, biases the holder 107 with a pressure greater than the pressure with which the carbonic acid gas charged into the bottle thrusts the acute end 106 of the needle 106 intruded into the inside of the carbonic acid gas cartridge bottle 5 through the pierced hole 14a of the lid 14. That is, the needle 106, held by the holder 107, is not extruded out of the pierced hole 14a by the gas pressure in the bottle even when the needle has been passed through the pierced hole 14a of the lid 14 so as to be intruded into the inside of the carbonic acid gas cartridge bottle 5. Thus, the carbonic acid gas, charged into the inside of the carbonic acid gas cartridge bottle 5, may be prevented from leaking out before the holder 107 is acted on by the actuating member 109.

The actuating member 109, adapted for ejecting the carbonic acid gas from the inside of the carbonic acid gas cartridge bottle 5, includes a lever member 120, engaged by the protuberant part 115 of the holder 107 and rotationally carried by the housing 1 10, and a thrust shaft 121 for thrusting the one end 120a of the lever member 120.

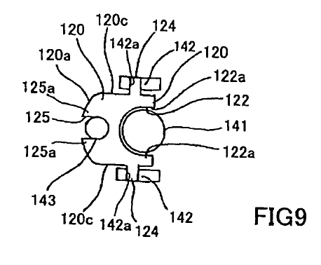

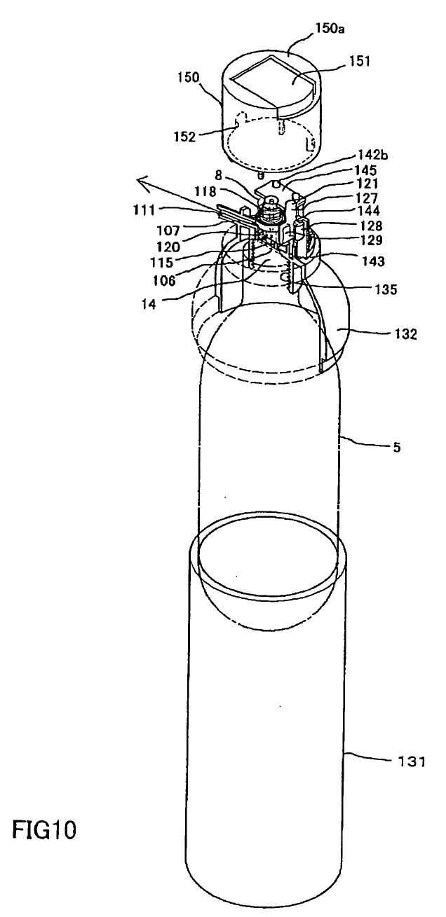

Referring to FIGS. 8 and 9, the lever member 120 includes a plate-shaped member, an opposite end 120b of which is cut out to a substantially arcuate shape conforming to the shape of a holder guide wall section 141 of the housing 110, to form a first cut-out 122. The first cut-out 122 includes facing sides 122a, 122a located below the flange part 117 of the holder 107. When the opposite end 120b of the lever member 120 is rotated upwards, the opposite end 120b compresses against the lug 119 protuberantly formed on the flange part 117 to thrust the holder 107 upwards. On outer lateral surfaces 120c, 120c of the lever member 120, there are protuberantly formed rotation lugs 124 carried by slits 142a of support wall sections 142 formed on the housing 110. These rotation lugs 124 are formed by columnar-shaped protrusions rotationally carried by the slits 142a of the support wall sections 142 as later explained. In the major surface side towards the one end 120a of the lever member 120 is formed a second cut-out 125 engaged by the thrust shaft 121. The second cut-out 125 is formed by cutting out the one end 120a of the lever member 120 to a substantially arcuate shape conforming to the shape of a thrust shaft guide wall section 143. In this recess 125 is intruded the thrust shaft 121. On the other hand, lateral sides 125a, 125a of the second recess 125 are thrust by a thrust lug 129 protuberantly formed on the thrust shaft 121. Thus, when the thrust shaft 121 is thrust, the lever member 120 is thrust by the thrust lug 129, so that its one end 120a is rotated downwards.

The thrust shaft 121, engaged with the second cut-out 125 of the lever member 120, includes a shaft part 127, a support piece 128 and the thrust lug 129. The shaft part is thrust by a user via an eject button 151 of a cap 150 provided on the upper housing section 132 of the housing 110, and the support piece is carried for movement in the up-and-down direction within the housing 110. The thrust lug compresses against the one end 120a of the lever member 120 to thrust and actuate the lever member. The shaft part 127 has its upper end thrust by the eject button 151 of the cap 150, while having its lower end passed through the thrust shaft guide wall section 143 provided within the housing 110 to guide the movement along the longitudinal direction of the thrust shaft 121. The support piece 128 has a substantially T-shaped cross-section and is formed for protruding along the longitudinal direction from a mid point along the longitudinal direction of the thrust shaft 121. This support piece 128 is movably engaged with a guide rail 144 mounted upright for extending along the direction of movement of the thrust shaft 121 within the housing 110. Hence, the movement of the thrust shaft 121 is also guided by this guide rail 144. The thrust lug 129 is formed for extending along the longitudinal direction at a mid point of the shaft part 127 for protruding in an opposite direction with respect to the support piece on both sides of the shaft part 127 so as to be engaged with the lateral sides 125a, 125a of the lever member 120. When the thrust shaft 121 is thrust, the thrust lug 129 compresses against the lateral sides 125a, 125a of the lever member 120 to cause the one end 120a of the lever member 120 to be rotated downwards.

With the actuating member 109, the opposite end 120b of the lever member 120, as referenced to the rotation lugs 124 of the lever member 120, is pushed downwards by the lug 119 protuberantly formed on the flange part 117 of the holder 107, biased at all times by the carbonic acid gas cartridge bottle 5 towards the carbonic acid gas cartridge bottle 5. Thus, the opposite end 120b of the lever member is rotated downwards, with the rotation lugs 24 as pivot, while its one end 120a is rotated upwards. Consequently, the thrust shaft 121 is thrust by the lateral sides 125a, 125a, provided on the one end 120a of the lever member 120, and hence is thrust upwards at all times.

When the eject button 151 of the cap 150 is thrust downwards by the user, the shaft part 127 of the thrust shaft 121 is thrust downwards by the eject button 151. Thus, the lower end of the shaft part 127 of the thrust shaft 121 is intruded into a recess 143a of the thrust shaft guide wall section 143. The support piece 128 is moved downwards as it is guided by the guide rail 144, whilst the thrust lug 129 thrusts the lateral sides 125a, 125a of the lever member 120 downwards. This causes the one end 120a of the lever member 120 to be rotated downwards, with the rotation lugs 124 as pivot, while causing the opposite end 120b to be rotated upwards. Since the paired lateral sides 122a, 122a, formed on the opposite end 120b of the lever member 120, compress against the lower surface of the lug 119 of the flange part 117, the holder 107 is uplifted, against the bias of the torsion coil spring 8, away from the lid 14 of the carbonic acid gas cartridge bottle 5. This causes the acute end 106a of the needle 106, carried by the holder 107, to be uplifted away from the lid 14 of the carbonic acid gas cartridge bottle 5, to permit ejection of the carbonic acid gas.

The housing 110, housing the carbonic acid gas cartridge bottle 5, holder 107 and the actuating member 109, is formed of a thermoplastic resin, such as ABS resin, to a substantially cylindrical shape, and is composed of a lower housing section 131 and an upper housing section 132. The carbonic acid gas cartridge bottle 5 and the holder 107 are accommodated in the lower housing section 131 and in the upper housing section 132, respectively. It is noted that the housing 110 is of a size to permit the user to hold the housing with one hand. A flow duct 111 for the carbonic acid gas is formed in the upper housing section 132 of the housing 111.

The lower housing section 131 is of a height and a diameter approximately the same as those of the carbonic acid gas cartridge bottle 5, and is capable of holding the carbonic acid gas cartridge bottle 5 in a manner free from idle movements.

The upper housing section 132, in which are accommodated the holder 107 and the actuating member 109, is formed as one with or detachably from the lower housing section 31. A lower surface section 132a of the upper housing section 132 is formed with a holder guide wall section 141 for guiding the movement of the protuberant part 115 of the holder 107, paired support wall sections 142, 142, a thrust shaft guide wall section 143, a pair of guide rails 144, 144 and a top plate 145. The support wall sections support the rotation lugs 124, 124 of the lever member 120, and the thrust shaft guide wall section guides the movement of the thrust shaft 121, whilst the guide rails are engaged with the support piece 128 of the thrust shaft 121. The top plate is provided at the upper ends of the paired support wall sections 142, 142 and is adapted for retaining one end of the torsion coil spring 8. The upper housing section 132 is covered by the cap 150 mounted on the lower surface section 132a of the upper housing section 132.

The holder guide wall section 141 is provided for protruding from the upper surface of the lower surface section 132a of the upper housing section 132 for slidably supporting the protuberant part 115 of the holder 107. In a recess 141a defined by the holder guide wall section 141 and into which is intruded the protuberant part 115 of the holder 107 is formed a through-hole 146 passed through by the needle 106 retained by the holder 107. This through-hole 146 is formed by the needle 106 piercing through the lower surface section 132a at the same time as the needle pierces through the lid 14 of the carbonic acid gas cartridge bottle 5 at the outset. Hence, the through-hole 44 is formed to the same diameter as the diameter of the needle 106. The lower surface section 132a is formed of a lubricious and repellant material, such as polyethylene, for guiding the movement of the needle 106. In addition, when the needle 106 is extracted from the pierced hole 14a of the lid 14, no gap is formed between the through-hole 146 and the needle 106 so that it is possible to prevent the carbonic acid gas from flowing into the upper housing section 132.

The rotation supports 142, 142 are formed for protruding from the upper surface side of the lower surface section 132a of the lower housing section 132, and are formed with slits 142a for rotationally supporting the rotation lugs 124, 124 of the lever member 120. The slits 142a are formed by opening the upper lateral sides of the support wall sections 142, 142. It is via these open ends that the rotation lugs 124, 124 of the lever member 120 are introduced. A plural number of engagement projections 142b, adapted for engaging with the top plate 145, are formed on the upper lateral sides of the support wall sections 142, 142.

The thrust shaft guide wall section 143 is formed on the upper surface side of the lower surface section 132a of the upper housing section 132 and slidably support the shaft part 127 of the thrust shaft 121 to guide the movement of the thrust shaft 121. The thrust shaft guide wall section 143 has a substantially circular recess 143a, conforming to the diameter of the shaft part 127 of the thrust shaft 121, and guides the thrust shaft 121 as the shaft part 127a is slid in the recess 143a.

The guide rails 144, 144 are protuberantly formed on the upper surface of the lower surface section 132a of the upper housing section 132 and are formed to a substantially L shape. The guide rails 144, 144 are arranged to a substantially U shape by placing the sides of the L shape face to face, to form a slit extending in the longitudinal direction. An open side of the letter U faces opposite to the thrust shaft 121. In the slit part is engaged the support piece 128 of the thrust shaft 121, having a substantially T-shaped cross-section, for slidably supporting the thrust shaft 121.

The top plate 145 includes a plural number of through-holes 145a in which are passed a plural number of the engagement projections 142b formed on the upper lateral sides of the support wall sections 142, 142. Into these through-holes 145a are passed the engagement projections 142b, whereby the top plate 145 is carried by the support wall sections 142, 142. The top plate 145 has its one end engaged by the opposite end of the torsion coil spring 8 having one end retained by the retention groove 116 formed in the flange part 117 of the holder 107. In this manner, the holder 107 is biased by the torsion coil spring 8 towards the carbonic acid gas cartridge bottle 5. The top plate 145 also includes a hole 145b passed through by the distal end 118a of the torsion coil spring fitting part 118 of the holder 106 and adapted for retaining the flange part 118b of the torsion coil spring fitting part 118.

A retention opening 135 for threaded engagement with the vicinity of the opening part 13 of the carbonic acid gas cartridge bottle 5 is formed in the lower surface of the lower surface section 132a of the upper housing section 132. In the retention opening 135 is formed a female screw thread for engaging with the opening part 13 of the carbonic acid gas cartridge bottle 5. When the carbonic acid gas cartridge bottle 5 is housed in the housing 110, the opening part 13 is carried by the retention opening 135, whereby the carbonic acid gas cartridge bottle is accommodated in a manner free from idle movements. At this time, there is formed in the carbonic acid gas cartridge bottle 5, between the lid 14 and the lower surface section 132a of the upper housing section 132, a clearance for forwarding the carbonic acid gas to the gas duct 111.

In the upper housing section 132, there is formed a gas duct 111 for forwarding to outside the carbonic acid gas, ejected outwards from the carbonic acid gas cartridge bottle 5. The gas duct 111 includes a conduit 147 directed from the lower surface section 132a of the upper housing section 132. The conduit 147 has its one end facing the retention opening 135 and separated i preset clearance from the lid 14 of the carbonic acid gas cartridge bottle 5 threadedly engaged with the retention opening 135. The opposite end of the conduit 147 faces outwards, so that the gas duct 111 may eject outwards the carbonic acid gas ejected from the pierced hole 14a of the lid 14.

A cap 150, provided on the upper housing section 132, is a hollow cylindrical casing, opened at its one end. The cap 150 may be attached to the upper housing section 132 to accommodate components, such as the holder 107 or the actuating member 109, mounted on the lower surface section 132a, and to permit the distal end of the conduit 147, carrying the gas duct 111, to face outwards.

On a closed upper surface section 150a of the cap 150, there is provided an eject button 151 for acting on a thrust shaft 121. In the outer rim of the cap 150, there is formed a cut-out 152 through which is intruded the distal end of the conduit 147. In the upper surface 150a of the cap 150, there is formed an opening part 153 in which is disposed the eject button 151. By forming the upper surface 150a as a rectangular cut-out, the opening part 153 is formed with its one end facing the outer rim of the upper surface 150a. The eject button 151, provided to this opening part 153, is rotationally coupled to the cap 150 via a hinge, not show, formed on the closed end of the opening part 153. The eject button 151 is abutted by one end of the shaft part 127 of the thrust shaft 121, so that, when the user acts on the eject button, the thrust shaft 121 is moved downwards. The eject button 151 is also thrust upwards by the thrust shaft 121, on which the force of bias of the torsion coil spring 8 acts via lever member 120.

The cut-out 152 is formed, by substantially arcuately cutting out a portion of the outer rim of the cap 150, so that the lower end of the cut-out faces the open end of the cap 151. The cut-out 152 is engaged by the distal end of the conduit 147 of the gas duct 111, from the open end side, by having the cap 150 mounted on the housing 10 from above the upper housing section 132.

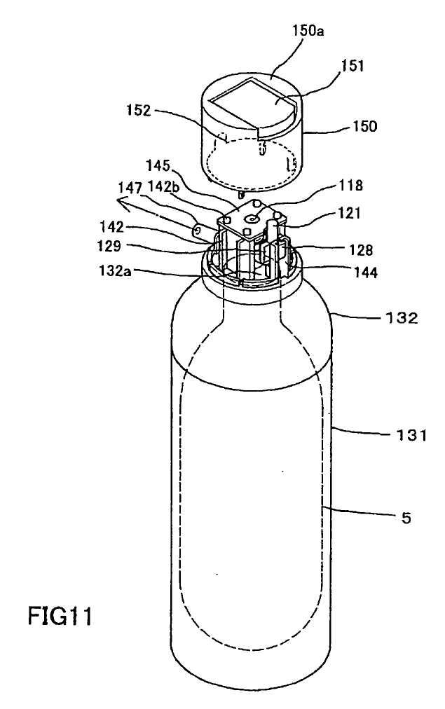

The gas ejection device 100 is assembled as shown in FIGS. 10 and 11. More specifically, the carbonic acid gas cartridge bottle 5 is mounted on the upper housing section 132, and the lower housing section 131 is mounted in position. The holder 106 and the actuating member 109 are mounted on the lower surface section 132a, on which there are provided the holder guide wall section 141, supporting wall sections 142, 142, thrust shaft guide wall section 143, guide rails 144, 144, top plate 145 and the conduit 147. The cap 150 is then mounted to the housing 110 for overlying the upper housing section 132.

With the gas ejection device 100, the opening/closing state of the carbonic acid gas cartridge bottle 5 can be checked with the holder 106 and the actuating member 109 mounted in position. That is, with the gas ejection device 100, the operating state can be checked, prior to mounting the cap 150, by retaining the holder 106 and the torsion coil spring 8 by the top plate 145 mounted on the support wall sections 142, 142. Hence, the labor of dismounting the cap 150 for checking for possible malfunctioning of the internal structure may be dispensed with, unlike the case where the holder and the torsion coil spring are retained by the cap and the cap is applied before proceeding to check the opening/closure operation of the carbonic acid gas cartridge bottle.

The operation during field use of the gas ejection device 100, arranged and constructed as described above, will now be described. In use of the gas ejection device 100, the ejection nozzle 156 is coupled to the conduit 147, provided in the upper housing section 132 of the housing 110, for interconnecting the gas duct 111 and the ejection nozzle 156, as shown in FIG. 7.

At this time, with the carbonic acid gas cartridge bottle 5, housed in the lower housing section 131 of the housing 110, the holder 107 is biased downwards by the torsion coil spring 8. Thus, with the gas ejection device 100, the acute end 106a of the needle 106, retained by the holder 107, pierces through the lid 14 to form an opening at the outset. In addition, the pierced hole 14a is closed by the acute end 106a of the needle 106 to prohibit ejection of the carbonic acid gas.

On the other hand, the lever member 120 of the actuating member 109, thrust downwards by the lug 119 of the holder 107, biased at all times towards the carbonic acid gas cartridge bottle 5 by the torsion coil spring 8, has its opposite end 120b rotated downwards, with the rotation lugs 124 as pivot, with its one end 120a being rotated upwards. Hence, the thrust shaft 121, having its thrust lug 129 engaged with the lateral sides 125a of the lever member 120, has its shaft part 127 thrust upwards for all time.

The user then holds the housing 110 of the gas ejection device 100 as an ejection port 156a, provided at the distal end of the ejection nozzle 156, will be directed towards a target for ejection. When the user thrusts the eject button 151 of the cap 150, the thrust lug 129 of the thrust shaft 121 is moved downwards, and hence the one end 120a of the lever 120, engaged with this thrust lug 129, are rotated downwards, with the rotation lugs 124 as pivot, with the opposite end 120b being rotated upwards. Hence, the facing sides 122a on the opposite end 120b of the lever member 120 compress against the lower surface of the lug 119 of the flange part 117. Consequently, the holder 107 is uplifted, against the bias of the torsion coil spring 8, away from the lid 14 of the carbonic acid gas cartridge bottle 5. Since this uplifts the acute end 106a of the needle 106, carried by the holder 107, from the pierced hole 14a of the lid 14 of the carbonic acid gas cartridge bottle 5, the carbonic acid gas, compressed in the bottle, is ejected outwards.

The carbonic acid gas, thus ejected, flows to the ejection nozzle 156, attached to the conduit 147, via gas duct 111 provided in the upper housing section 132 of the housing 110, so as to be released via ejection port 156a of the ejection nozzle 156.

When the thrusting by the user on the eject button 151 of the actuating member 109 is released, the holder 107 is biased towards the carbonic acid gas cartridge bottle 5, under the bias of the torsion coil spring 8. Thus, the acute end 106a of the needle 106, carried by the holder 107, is passed through the pierced hole 14a of the lid 14 of the carbonic acid gas cartridge bottle 5, for stoppering the carbonic acid gas cartridge bottle 5. This causes cessation of ejection of the carbonic acid gas from the ejection nozzle 156.

On the other hand, the lever member 120 has its opposite end 120b thrust by the lug 119 of the holder 107, biased towards the carbonic acid gas cartridge bottle 5, so that its one end 120a is rotated upwards, with the rotation lugs 124 as pivot. Thus, the thrust shaft 121, engaged with the one end 120a of the lever member 120, has its shaft member 127 shifted upwards, so that the eject button 151 of the cap 150, compressing against the shaft part 127, is also uplifted towards the upper surface 150a.

Thus, in the gas ejection device 100, when the carbonic acid gas has been charged in the carbonic acid gas cartridge bottle 5, formed by a metal enclosure, and the carbonic acid gas is not being sprayed, the holder 107 is biased towards the carbonic acid gas cartridge bottle 5, so that the acute end 106a of the needle stops up the lid 14 of the carbonic acid gas cartridge bottle 5 to inhibit ejection of the carbonic acid gas. Thus, with the gas ejection device 100, ejection control of the carbonic acid gas can be performed reliably despite its simple configuration of introducing and extruding the needle 106 for the lid 14.

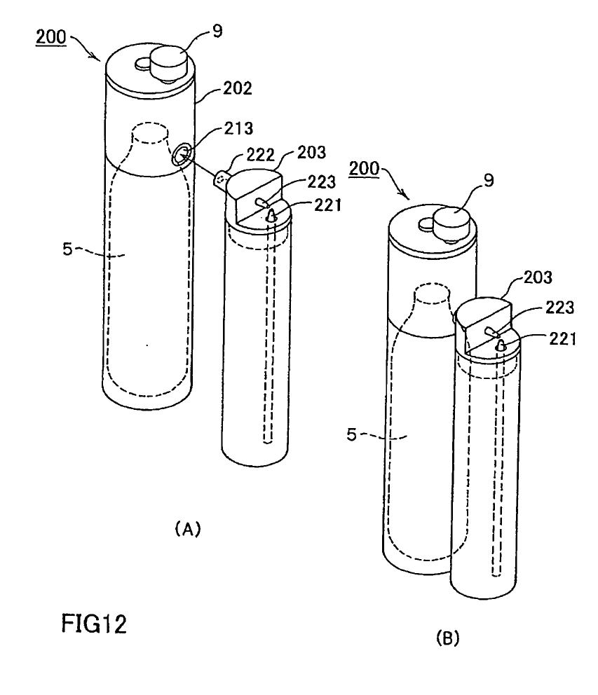

A spraying device 200, embodying the present invention, will now be described in detail with reference to the drawings. The components which are the same as those of the gas ejection device 1 are depicted by the same reference numerals and detailed description is dispensed with. Referring to FIG. 12, this spraying device 200 includes a gas bottle cartridge 202, having housed therein a carbonic acid gas cartridge bottle 5, charged with a carbonic acts gas for spraying the liquid as a liquid mist, and a liquid tank 203, detachably mounted on the gas bottle cartridge 202. FIG. 12(A) shows the state in which the gas bottle cartridge 202 and the liquid tank 203 are detached from each other, and FIG. 12(B) shows the state in which the gas bottle cartridge 202 and the liquid tank 203 are attached to each other.

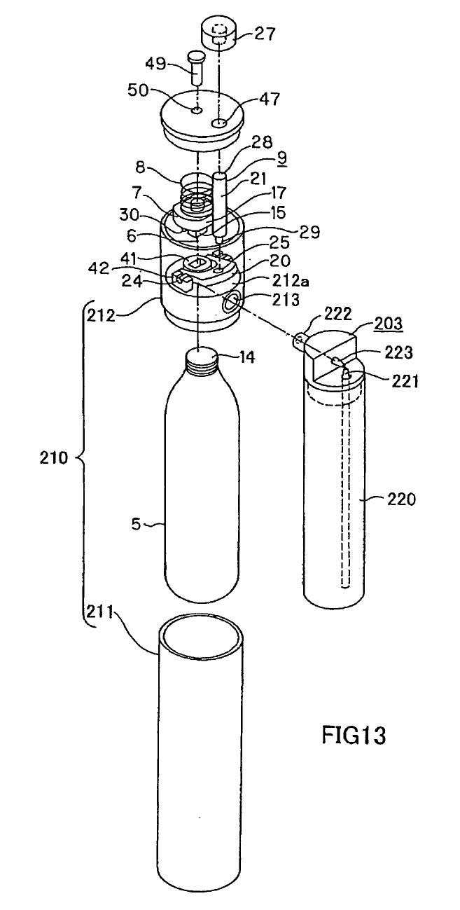

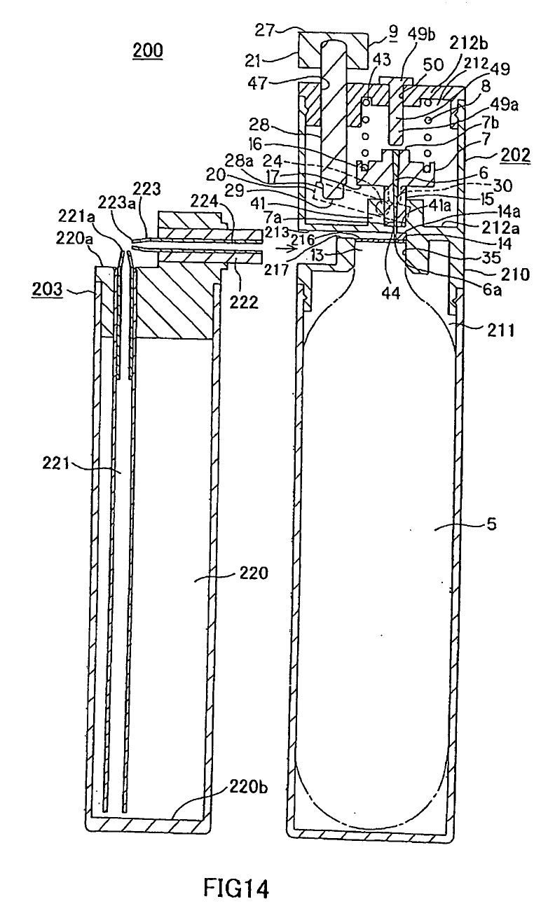

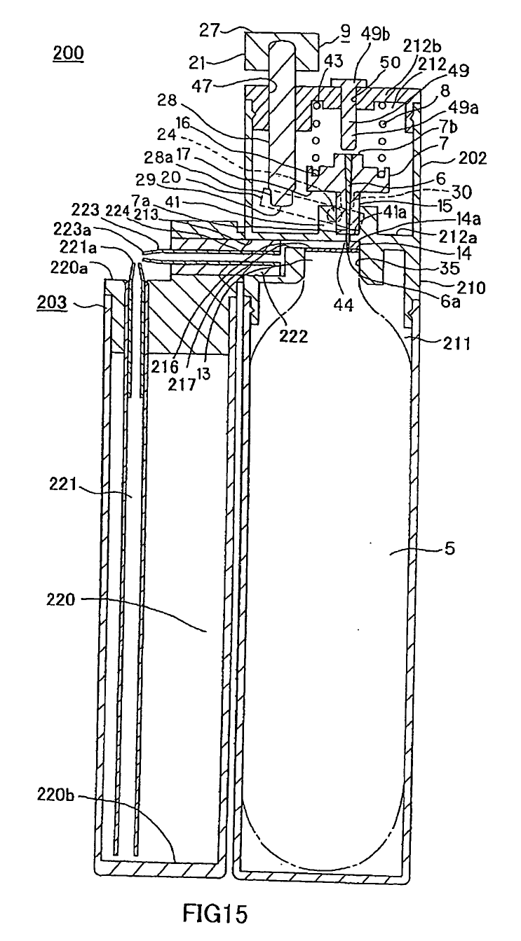

Referring to FIGS. 13 and 14, the gas bottle cartridge 202 includes a carbonic acid gas cartridge bottle 5, charged with the carbonic acid gas, and a holder 7 for carrying a needle 6 for opening the carbonic acid gas cartridge bottle 5. The gas bottle cartridge 202 also includes a torsion coil spring 8 for biasing the holder 7 towards the opening part of the carbonic acid gas cartridge bottle 5, and an actuating member 9 for actuating the holder 7 in a direction of separating the holder 7 and the opening part of the carbonic acid gas cartridge bottle 5 from each other for releasing the carbonic acid gas. The gas bottle cartridge 202 also includes a housing 210 for accommodating the carbonic acid gas cartridge bottle 5 and the holder 7.

It is noted that the carbonic acid gas cartridge bottle 5, needle 6, holder 7, torsion coil spring 8 and the actuating member 9 are similar to the corresponding components of the gas ejection device 1 and hence are depicted by the same reference numerals, while the detailed description is dispensed with.

The housing 210, having housed therein the carbonic acid gas cartridge bottle 5 and the holder 7, is formed to a tubular shape from a thermoplastic resin, such as ABS resin, and is made up by a lower housing section 211 and an upper housing section 212. In the lower housing section and in the upper housing section, there are accommodated the carbonic acid gas cartridge bottle 5 and the holder 7, respectively. The housing 10 is of a size that permits the operation by a user with one hand. Between the lower housing section 211 and the upper housing section 212 of the housing 210, there is formed, in addition to a flow duct for the carbonic acid gas, a mating coupling part 213 to which is inserted a coupling part 222 for the liquid tank 203 as later explained.

The lower housing section 211 is of a height and a diameter approximately the same as those of the carbonic acid gas cartridge bottle 5, and is capable of holding the carbonic acid gas cartridge bottle 5 without idle movements.

The upper housing section 212, in which is accommodated the holder 7, is formed as one with or detachably from the lower housing section 211. The upper housing section 212 is formed with a guide wall section 41 for guiding the movement of the protuberant part 15 of the holder 7, paired rotation supports 42, 42 and a retainer 43 for retaining one end of the torsion coil spring 8. The paired rotation supports support the rotation lugs 24, 24 of the lever member 20.

The guide wall section 41 is protuberantly formed on a lower surface section 212a of the upper housing section 212 to slidably support the protuberant part 15 of the holder 7. In a recess 41a, delimited by the guide wall section 41, and into which is introduced the protuberant part 15 of the holder 7, there is formed a through-hole 44 to be passed through by the needle 6 provided on the holder 7. This through-hole 44 is formed at the outset by the needle 6 pierced through the lower surface section 212a at the same time as the needle pierces through the lid 14 of the carbonic acid gas cartridge bottle 5. Hence, the through-hole 44 is formed to the same diameter as the diameter of the needle 6. The lower surface section 212a is formed of a lubricious and repellant material, such as polyethylene, for guiding the movement of the needle 6. In addition, when the needle 6 is extracted from the pierced hole 14a of the lid 14, no gap is formed between the through-hole 44 and the needle 6 so that it is possible to prevent the carbonic acid gas from flowing into the upper housing section 212.

The rotation supports 42, 42 are formed for protruding from the lower surface section 212a of the upper housing section 212, and are formed with support recesses for rotationally supporting the rotation lugs 24, 24 of the lever member 20.

The retainer 43 is formed in an upper surface section 212b of the upper housing section 212 for engagement with the opposite end of the torsion coil spring 8 which has its one end retained in the retention groove 16 formed in the flange part 17 of the holder 7. This biases the holder 7 towards the carbonic acid gas cartridge bottle 5 under the force of the torsion coil spring 8.

In a lower surface side of the upper housing section 212 is formed a tapped hole 35 for threaded engagement with the vicinity of the opening part 13 of the carbonic acid gas cartridge bottle 5. Thus, when accommodated within the housing 10, the carbonic acid gas cartridge bottle 5 may have its opening part 13 carried by the tapped hole 35 and may thereby be retained in a state free from idle movements.

In the upper housing section 212, there is formed a window 216 for causing the lid 14 of the carbonic acid gas cartridge bottle 5 to face the mating coupling part 213 for the liquid tank 203. The needle 6 retained by the holder 7 is inserted into the upper housing section 212 via this window 216 for closing and sealing the lid 14 of the carbonic acid gas cartridge bottle 5. This window 216 communicates with the mating coupling part 213, into which is inserted the coupling part 222 of the liquid tank 203, such as to form a gas duct 217 for forwarding the ejected carbonic acid gas via window 216 towards the mating coupling part 213.

The lower part of the upper housing section 212 includes the mating coupling part 213 by which the liquid tank 203 is mounted to or dismounted from the gas bottle cartridge 202. The mating coupling part 213 is formed to, for example, a circular recess by cutting out the lower lateral surface of the upper housing section 212 in such a manner as to permit the coupling part 222 of the liquid tank 203 to fit in the so formed recess. The mating coupling part 213 is in communication with the gas duct 217 defined by the window 216, formed in the upper housing section 212, and by the lower surface section 212a of the upper housing section 212, facing the window 216 with a preset clearance in-between, and causes the gas duct 217 to face outwards. When the coupling part 222 of the liquid tank 203 is fitted to this mating coupling part 213, the gas duct 217 communicates with a nozzle 223 intruded into the coupling part 222 to forward the carbonic acid gas ejected from the cartridge bottle 5 towards the liquid tank 203.

The liquid tank 203 includes a tank part 220, charged with a liquid to be ejected, and a liquid tube 221 for forwarding the liquid, charged in the tank part 220, to outside the tank part 220. The liquid tank 203 also includes the coupling part 222, attached to the mating coupling part 213 of the gas bottle cartridge 202, and the nozzle 223 provided in the coupling part 222 and connected by the mating coupling part 213 to the gas duct 217.

The tank part 220, charged with the liquid, is formed as, for example, a cylindrical vessel, and is charged with a liquid, such as a paint for coating, ink, face lotion, a liquid foundation, or a liquid condiment, such as soybean sauce. An upper surface section 220a of the tank part 220 is provided with the coupling part 222 fitted with the nozzle 223. The liquid tube 221 for forwarding the liquid towards an ejection port 223a of the nozzle 223 is provided for extending through the inside of the tank part 220.

The liquid tube 221 is provided for extending from a bottom section 220b up to the upper surface section 220a of the tank part 220. An upper extreme end of the liquid tube 221 is provided with an ejection port 221a overlying the upper surface section 220a of the tank part 220. The ejection port 221a of the liquid tube 221 is provided at a location slightly offset from the center of the upper surface section 220a of the substantially circular tank part 220 and proximate to the distal end of the nozzle 223 as later explained.

The coupling part 222, mounted on the gas bottle cartridge 202, is protruded in an opposite direction to the direction of offset of the ejection port 221a of the liquid tube 221 on the upper surface section 220a of the tank part 220. This coupling part 222 is shaped in conformity to the shape of the mating coupling part 213 of the gas bottle cartridge 202. For example, the coupling part is formed to a columnar shape that may fit into the mating coupling part 213 formed as a circular recess, and has a tight fit in the mating coupling part 213.

The coupling part 222 includes a hollow part 224 extending along the protruding direction, and the nozzle 223 is fitted in this hollow part 224. When the coupling part 222 is mounted on the mating coupling part 213, the nozzle 223 communicates with the gas duct 217, facing outwards via gas duct 217, so that the carbonic acid gas may be ejected via nozzle 223.

The nozzle 223, fitted to the hollow part 224 of the coupling part 222, is extended is a direction substantially at right angles to the direction of extension of the liquid tube 221, provided in the tank part 220. The ejection port 223a, formed at the distal end of the nozzle 223, is provided in proximity to the ejection port 221a of the liquid tube 221. When the carbonic acid gas flows from the gas duct 217 of the gas bottle cartridge 202 into the nozzle, the carbonic acid gas is ejected via ejection port 223a at the distal end of the nozzle. Since the ejection port 223a of the nozzle 223 is mounted in proximity to the ejection port 221a of the liquid tube 221, the pressure in the ejection port 221a of the liquid tube 221 is negative. Hence, the liquid charged in the tank part 220 rises through the liquid tube ;21 so as to be emitted via ejection port 221a. The liquid emitted from the ejection port 221a is mixed into the carbonic acid gas ejected from the nozzle 223 and is transformed into mist which is then ejected along with the carbonic acid gas. The liquid mist, mixed into the carbonic acid gas, becomes finer in particle size, such that, when it is the liquid foundation that is sprayed, the sprayed mist clings more intimately to the skin. On the other hand, the paint or the liquid condiment may be sprayed uniformly.

The operation of the above-described spraying device 200 during field use will now be described. During field use of the spraying device 200, the coupling part 222 of the liquid tank 203, the tank part 220 of which has been charged e.g. with a liquid foundation, is connected to the mating coupling part 213 of the gas bottle cartridge 202, as shown in FIG. 15. This sets up communication between the nozzle 223 fitted to the coupling part 222 and the gas duct 217 formed in the gas bottle cartridge 202.

At this time, in the carbonic acid gas cartridge bottle 5, housed in the lower housing section 211 of the gas bottle cartridge 202, as shown in FIG. 5, the holder 7 is biased downwards by the torsion coil spring 8. Hence, the acute part 6a of the needle 6, held by the holder 7, pierces through the lid 14 to form a pierced hole 6a at the outset. This pierced hole 6a is stopped up by the acute part 6a of the needle 6 to prohibit ejection of the carbonic acid gas.

The lever member 20 of the actuating member 9 is pressed down by the push-down boss 30 of the holder 7, biased at all times by the torsion coil spring 8 towards the carbonic acid gas cartridge bottle 5. Thus, the opposite end 20b of the lever member 20 is rotated downwards, with rotation lugs 24 as pivot, while the one end 20a of the lever member is rotated upwards, as shown in FIG. 15. Since the operating button 21 is engaged with the one end 20a of the lever member 20, the operating part 27 is pressed upwards at all times.

The user then holds the housing 210 of the gas bottle cartridge 202, as he/she directs an ejection end 223a of the ejection nozzle 223 towards a target for ejection. When the user then thrusts the actuating button 21 of the actuating member 9, the one end 28a of the thrust shaft 28 is moved downwards, so that the one end 20a of the lever member 20, engaged with the thrust shaft 28, is rotated downwards, as shown in FIG. 6. The one end 20a of the lever member 20, engaged with the thrust shaft 28, is rotated downwards, about the rotation lugs 24 as pivot, while the other end 20b is rotated upwards. Since the paired facing sides 22a, formed at the opposite end 20b of the lever member 20, abut against the lower face of the push-down boss 30 of the flange part 17, the holder 7 is uplifted, against the bias of the torsion coil spring 8, away from the lid 14 of the carbonic acid gas cartridge bottle 5. This uplifts the acute end 6a of the needle 6, carried by the holder 7, away from the pierced hole 14a of the lid 14 of the carbonic acid gas cartridge bottle 5, thus ejecting the carbonic acid gas compressed in the bottle.

The carbonic acid gas ejected flows towards the gas duct 217 via the window 216 formed in the lower housing section 211 of the housing 210 and thence towards the nozzle 223 of the coupling part 222 mounted to the mating coupling part 213 so as to be ejected via ejection port 223a of the nozzle 223. Since the ejection port 223a of the nozzle 223 is mounted in proximity to the ejection port 221a of the liquid tube 221, the pressure in the liquid tube 221 is negative when the carbonic acid gas is ejected from the nozzle 223. Hence, the liquid charged in the tank part 220 rises through the liquid tube 221 so as to be emitted via ejection port 221a. The liquid emitted from the ejection port 221a is mixed into the carbonic acid gas ejected from the nozzle 223 and is transformed into mist which then is ejected along with the carbonic acid gas.

In this spraying device 200, the ejection port 221a of the liquid tube 221 is disposed at a location slightly offset from the center of the circular upper surface section 220a of the tank part 220, and the ejection port 223a of the nozzle 223, fitted to the coupling part 222, ejects the carbonic acid gas along, the direction of offset of the ejection port 221a of the liquid tube 221. Hence, the liquid sprayed may be supplied evenly to the target of spraying, without being obstructed by the upper surface section 220a of the tank part 220.

The depth of intrusion of the shaft part 49a of the control member 49 may be adjusted at the outset by manually rotating the shaft part 49a for thereby adjusting the position of abutment of the distal end of the shaft part 49a on the upper surface 7b of the holder 7. By so doing, the shaft part 49a of the control member 49 compresses against the upper surface 7b of the holder 7, even when the holder 7 is uplifted by the actuating member 9, for controlling the uplifting of the holder 7 to permit the flow of the carbonic acid gas to be adjusted for prevent the carbonic acid gas from being ejected in excessive quantities.

When the thrusting by the user on the actuating button 21 of the actuating member 9 is released, the holder is biased towards the carbonic acid gas cartridge bottle 5 under the bias of the torsion coil spring 8. Hence, the acute member 6a of the needle 6, retained by the holder 7, is passed through the pierced hole 14a of the lid 14 of the carbonic acid gas cartridge bottle 5 to stop up the carbonic acid gas cartridge bottle 5. This halts the ejection of the carbonic acid gas from the nozzle 223 to stop the ejection of the liquid.

The opposite end 20b of the lever member 20 is thrust by the push-down boss 30 of the holder 7, biased towards the carbonic acid gas cartridge bottle 5, and hence the one end 20a of the lever member 20 is rotated upwards, with the rotation lugs 24 as pivot. Consequently, the actuating button 21, engaged with the one end 20a of the lever member 20, and hence the thrust shaft 28, are moved upwards, so that the operating part 27 is uplifted above the upper surface 212b.

Thus, when the liquid is not being sprayed, the holder 7 is biased towards the carbonic acid gas cartridge bottle 5, so that the acute end 6a of the needle 6 stops up the lid 14 of the carbonic acid gas cartridge bottle 5 to prohibit the spraying of the carbonic acid gas. Hence, even if once the gas bottle cartridge 202 and the liquid tank 203 are assembled together, the gas bottle cartridge 202 may be detached in safety from the liquid tank 203, without the risk of inadvertent ejection of the carbonic acid gas or frost injury otherwise caused by the heat of vaporization.

Moreover, with the spraying device 200, in case there is left a residual amount of the carbonic acid gas in the carbonic acid gas cartridge bottle 5, the gas bottle cartridge 202 may still be used by attaching the gas bottle cartridge to the liquid tank 203 currently used, or to a new liquid tank.

In the spraying device 200, the needle 6 pierces through the lid 14, by the holder 7 being biased by the torsion coil spring 8 towards the carbonic acid gas cartridge bottle 5, by way of stoppering the lid. Hence, even if the gas bottle cartridge 202 is inadvertently dropped before mounting the gas bottle cartridge to the coupling part 222 of the liquid tank 203, there is no risk of inadvertent ejection of the carbonic acid gas or frost injury otherwise caused by the heat of vaporization to assure safe handling.

In the spraying device according to the present invention, the gas bottle cartridge may be formed as one with the liquid tank, in place of -separately providing the gas bottle cartridge and the liquid tank and attaching them together for use for spraying. Even in such case, if the carbonic acid gas has been charged in the gas bottle cartridge formed by a metal enclosure and the carbonic acid gas is not being sprayed, the holder 7 is biased towards the gas bottle cartridge and the acute end 6a of the needle 6 stops up the lid 14 of the carbonic acid gas cartridge bottle 5 to inhibit the spraying of the carbonic acid gas. Hence, the ejection control of the carbonic acid gas may be achieved reliably by a simplified configuration of intruding and extracting the needle 6 for the lid 14.

The spraying device according to the present invention may be configured as a spraying device 300 as now described. In the spraying device 300, the same components as those described in connection with the gas ejection devices 1, 100 and the spraying device 200 are depicted by the same reference numerals and detailed description is dispensed with.

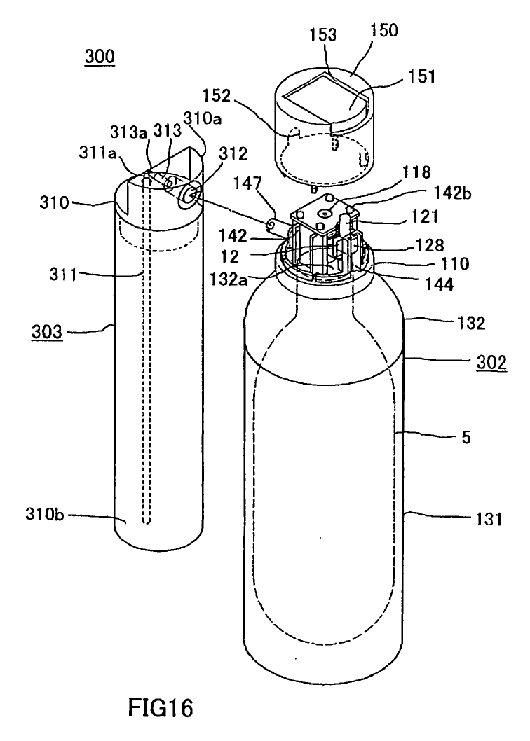

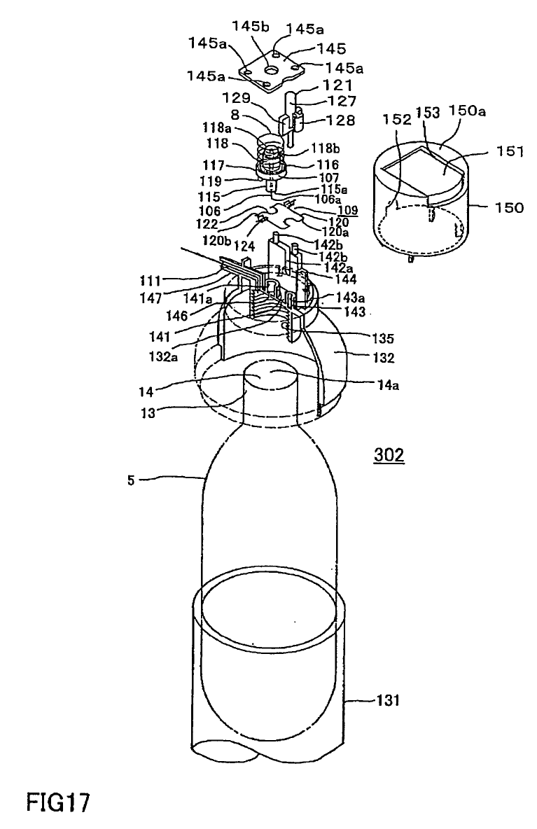

Referring to FIG. 16, the spraying device 300 includes a gas bottle cartridge 302 and a liquid tank 303 detachably mounted to the gas bottle Cartridge 302. In this gas bottle cartridge 302, there is housed a carbonic acid gas cartridge bottle 5 charged with a carbonic acid gas used for spraying the liquid in the form of a mist. Referring to FIGS. 16 and 17, the gas bottle cartridge 302 includes the carbonic acid gas cartridge bottle 5, charged with carbonic acid gas, as compressed gas, a holder 107, a torsion coil spring 8, an actuating member 109 and a housing 110. The holder 107 holds a needle 106 for opening/closing the carbonic acid gas cartridge bottle 5, and the torsion coil spring 8 biases the holder 107 towards an opening part of the carbonic acid gas cartridge bottle 5. The actuating member 109 actuates the holder 107 in a direction away from the opening part of the carbonic acid gas cartridge bottle 5 to release the carbonic acid gas. The housing 110 has the carbonic acid gas cartridge bottle 5, holder 107 and the actuating member 109 housed therein and includes a gas duct 111 for forwarding the carbonic acid gas ejected from the carbonic acid gas cartridge bottle 5 to outside.

Meanwhile, the carbonic acid gas cartridge bottle 5, needle 106, holder 107, torsion coil spring 8, actuating member 109, gas duct 111 and the housing 110, as well as other components, are similar in structure to the corresponding components of the gas ejection devices 1, 100 or the spraying device 200. Hence, these are depicted by the same reference numerals and the detailed description is dispensed with.

Out of these components, the conduit 147, formed in the housing 110 of the gas bottle cartridge 302, has its one end communicating with a preset clearance with the lid 14 of the carbonic acid gas cartridge bottle 5, while having its other end protruded outwards and intruded into a connection hole 312 formed in the liquid tank 303. The lid 14 of the carbonic acid gas cartridge bottle faces the inside of the retention opening 135 and is threaded to a female thread of the retention opening 135. Thus, the conduit provides for communication between the gas duct 111 and the nozzle 313 of the liquid tank 303 to permit the carbonic acid gas to be ejected at an ejection port 313a of the nozzle 313.

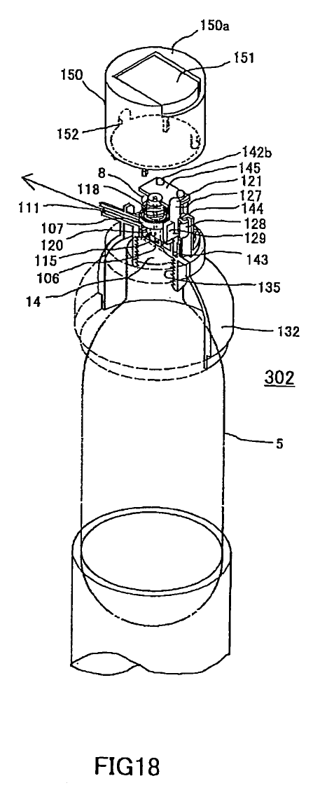

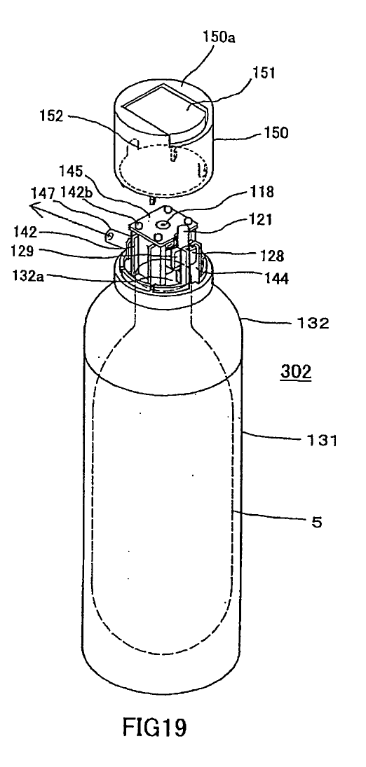

Referring to FIGS. 18 and 19, the gas bottle cartridge 302, described above, is assembled in a manner similar to the gas ejection device 100. That is, the carbonic acid gas cartridge bottle 5 is mounted on the upper housing section 132, and the lower housing section 131 is mounted in position. The holder 106 and the actuating member 109 are then mounted on the lower surface section 132a on which there are provided the holder guide wall section 141, support wall sections 142, 142, thrust shaft guide wall section 143, guide rails 144, 144, top plate 145 and the conduit 147. Finally, the cap 150 is mounted on the housing 110 in a manner of overlying the upper housing section 132.

With the gas bottle cartridge 302, the opening/closing operation of the carbonic acid gas cartridge bottle 5 may be checked as the holder 106 and the actuating member 109 have been mounted in position. That is, the operation of the gas bottle cartridge 302 can be checked prior to the mounting of the cap 150, by having the holder 106 and the torsion coil spring 8 retained by the top plate 145 mounted on the support wall sections 142, 142. Thus, unlike the case where the carbonic acid gas cartridge bottle 5 is checked as to its opening/closing operation after the holder and the torsion coil spring are retained by the cap and the cap is mounted in position, it becomes possible to save the labor of dismounting the cap 150 in order to check for possible failure of the inner structure.

The liquid tank 303, to be connected to the gas bottle cartridge 302 via conduit 147, includes a tank part 310, charged with the liquid to be ejected, a liquid tube 311, a connection port 312 and a nozzle 313. The liquid tube 311 is used for forwarding the liquid, charged in the tank part 310, to outside the tank part 310, and the connection port 312 is used for connecting the conduit 147 of the gas bottle cartridge 302 thereto. The nozzle 313 is provided within the connection port 312 and adapted for communicating via conduit 147 with the gas duct 111.

The tank part 310, charged with the liquid, is formed as, for example, a cylindrical vessel, and is charged with a liquid, such as a paint for coating, ink, face lotion, a liquid foundation, or a liquid condiment, such as soybean sauce. An upper surface section 310a of the tank part 310 is provided with the connection port 312 communicating with the nozzle 313. The liquid tube 311 for forwarding the liquid towards an ejection port 313a of the nozzle 313 is provided for extending through the inside of the tank part 310.

The liquid tube 311 is provided for extending from a bottom section 310b up to the upper surface section 310a of the tank part 310. An upper extreme end of the liquid tube is provided with an ejection port 311a overlying the tipper surface section 310a of the tank part 310. The ejection port 311a of the liquid tube 311 is provided at a location slightly offset from the center of the upper surface section 310a of the substantially circular tank part 310 and proximate to the distal end of the nozzle 313 as later explained.

The connection port 312, inserted into the conduit 147 of the gas bottle cartridge 302, is formed for protruding in a direction opposite to the direction of offset of the ejection port 311a of the liquid tube 311 on the upper surface section 310a of the tank part 310. This connection port 312 is profiled to the shape of the conduit 147 of the gas bottle cartridge 302. For example, the connection port 312 is circular in profile for the cylindrically-shaped conduit 147 to fit therein, and is connected without interstices to the conduit 147.

The nozzle 313 is fitted to the side of the connection port 312 opposite to the side for intrusion of the conduit 147. When the conduit 147 is inserted into the connection port 312, the nozzle 313 is connected to the gas duct 111 via conduit 147 to permit the carbonic acid gas to be ejected from the nozzle 313.

The nozzle 313, fitted into the connection port 312, is extended in a direction substantially at right angles to the direction of extension of the liquid tube 311 provided in the tank part 310. The ejection port 313a at the distal end of the nozzle is proximate to the ejection port 311a of the liquid tube 311. When the carbonic acid gas flows into the nozzle 313 from the gas duct 111 of the gas bottle cartridge 302, the carbonic acid gas is ejected via ejection port 313a at the distal end of the nozzle. Since the ejection port 313a of the nozzle 313 is mounted in proximity to the ejection port 311a of the liquid tube 311, the pressure in the ejection port 311a of the liquid tube 311 is negative. Hence, the liquid charged in the tank part 310 rises through the liquid tube 311 so as to be emitted via ejection port 311a. The liquid emitted from the ejection port 311a is mixed into the carbonic acid gas ejected from the nozzle 313 and is transformed into mist which then is ejected along with the carbonic acid gas. The liquid mist, mixed into the carbonic acid gas, becomes finer in particle size, such that, when it is the liquid foundation that is sprayed, the sprayed mist clings more intimately to the skin. On the other hand, the paint or the liquid condiment may be sprayed uniformly.

The operation during actual field use of the spraying device 300, described above, will now be explained. During actual field use of the spraying device 300, the conduit 147 provided in the upper housing section 132 of the housing 110 is intruded into the connection port 312 to establish communication between the gas duct 111 and the nozzle 313, as shown in FIG. 16.

The carbonic acid gas cartridge bottle 5 is housed in the lower housing section 131 of the housing 110. The holder 107 is biased downwards by the torsion coil spring 8. Thus, in the spraying device 300, the acute end 106a of the needle 106, held by the holder 107, is passed through the lid 14 at the outset to form a pierced hole 14a which is simultaneously stopped up with the acute end 106a of the needle 106 to inhibit the ejection of the carbonic acid gas.

Moreover, the lever member 120 of the actuating member 109 is pushed down by the actuating member 109 of the holder 107 which is biased at all times by the torsion coil spring 8 towards the carbonic acid gas cartridge bottle 5. Thus, the lever member 120 has its opposite end 120b rotated downwards with the rotation lugs 124 as pivot, while having its one end 120a rotated upwards. Hence, the thrust shaft 121, the thrust lug 129 of which is engaged with the lateral sides 125a of the lever member 120, has its shaft part 127 uplifted for all time.

The user then holds the spraying device 300 as he/she directs the ejection port 313a, formed at the distal end of the ejection nozzle 313, towards a target for ejection. When the user then thrusts the actuating button 151 of the cap 150, the thrust lug 129 of the thrust shaft 121 is moved downwards. Hence, the one end 120a of the lever member 120, engaged with the thrust lug 129, is rotated downwards, with the rotation lugs 124 as pivot, while the other end 120b is rotated upwards. Thus, the facing sides 122a, formed on the opposite end 120b of the lever member 120, compress against the lower side of the lug 119 of the flange part 117, so that the holder 107 is uplifted, against the bias of the torsion coil spring 8, away from the lid 14 of the carbonic acid gas cartridge bottle 5. This Uplifts the acute end 106a of the needle 106, carried by the holder 107, out of the pierced hole 14a of the lid 14 of the carbonic acid gas cartridge bottle 5, thus ejecting the carbonic acid gas compressed in the cartridge bottle 5.

The carbonic acid gas, thus ejected, flows via conduit 147 provided in the upper housing section 132 of the housing 110 into the nozzle 313 communicating with the gas duct 111, so as to be ejected via ejection port 313a of the nozzle 313.

Since the ejection port 313a of the nozzle 313 is mounted in proximity to the ejection port 311a of the liquid tube 311, the pressure in the ejection port 311a of the liquid tube 311 at this time is negative. Hence, the liquid charged in the tank part 310 rises through the liquid tube 311 so as to be emitted via ejection port 311a. The liquid emitted from the ejection port 311a is mixed into the carbonic acid gas ejected from the nozzle 313 and is transformed into mist which then is ejected along with the carbonic acid gas.

When the thrusting by the user on the actuating button 151 of the actuating member 109 is released, the holder 107 is biased towards the carbonic acid gas cartridge bottle 5 under the bias of the torsion coil spring 8. Hence, the acute end 106a of the needle 106, held by the holder 107, is passed through the pierced hole 14a of the lid 14 of the carbonic acid gas cartridge bottle 5 to stop up the carbonic acid gas cartridge bottle 5. This halts the ejection of the carbonic acid gas from the nozzle 313.

On the other hand, the lever member 120 has its opposite end 120b thrust by the lug 119 of the holder 107, biased towards the carbonic acid gas cartridge bottle 5, so that its one end 120a is rotated upwards, with the rotation lugs 124 as pivot. Thus, the thrust shaft 121, engaged with the one end 120a of the lever member 120, has its shaft member 127 shifted upwards, so that the eject button. 151 of the cap 150, compressing against the shaft part 127, is also uplifted towards the upper surface 150a.

Thus, in the gas ejection device 300, when the carbonic acid gas has been charged in the carbonic acid gas cartridge bottle 5, formed by a metal enclosure, and the carbonic acid gas is not being sprayed, the holder 107 is biased towards the carbonic acid gas cartridge bottle 5, so that the acute end 106a of the needle 106 stops up the lid 14 of the carbonic acid gas cartridge bottle 5 to inhibit ejection of the carbonic acid gas. Thus, with the spraying device 300, ejection control of the carbonic acid gas can be performed reliably despite its simple configuration of introducing and extruding the needle 106 for the lid 14.

Also, in the spraying device 300, when the liquid is not being sprayed, the holder 107 is biased towards the carbonic acid gas cartridge bottle 5, so that the acute end 106a of the needle 106 stops up the lid 14 of the carbonic acid gas cartridge bottle 5 to inhibit ejection of the carbonic acid gas. Thus, with the spraying device 300, even if once the gas bottle cartridge 302 and the liquid tank 303 are assembled together, the gas bottle cartridge 302 may be dismounted in safety from the liquid tank 303, without the risk of inadvertent ejection of the carbonic acid gas or frost injury otherwise caused by the heat of vaporization.

Moreover, with the spraying device 300, in case there is left a residual amount of the carbonic acid gas in the carbonic acid gas cartridge bottle 5, the gas bottle cartridge 302 may still be used by attaching the gas bottle cartridge to the liquid tank 303 currently used, or to a new liquid tank.

In the spraying device 300, the needle 106 pierces through the lid 14, by the holder 107 being biased by the torsion coil spring 8 towards the carbonic acid gas cartridge bottle 5, by way of stopping up the lid. Thus, even if the gas bottle cartridge 302 is inadvertently dropped before mounting the gas bottle cartridge to the coupling part 312 of the liquid tank 303, there is no risk of inadvertent ejection of the carbonic acid gas or frost injury otherwise caused by the heat of vaporization to assure safe handling.

In the spraying device 300, the gas bottle cartridge may be formed as one with the liquid tank, in place of separately providing the gas bottle cartridge and the liquid tank and attaching them together for use for spraying. Even in such case, if the carbonic acid gas has been charged in the gas bottle cartridge formed by a metal enclosure and the carbonic acid gas is not being sprayed, the holder 7 is biased towards the gas bottle cartridge and the acute end 6a of the needle 6 stops up the lid 14 of the carbonic acid gas cartridge bottle 5 to inhibit the spraying of the carbonic acid gas. Thus, the ejection control of the carbonic acid gas may be achieved reliably by a simplified configuration of intruding and extracting the needle 6 for the lid 14.

1. A gas ejection device comprising:
a bottle having an opening part closed by a lid, said bottle being charged with a compressed gas in advance;
a needle intruded through a pierced hole formed in said lid for stopping up said lid;
a holder holding said needle at one end thereof in a facing relation to said lid of said bottle and movable towards and away from said lid;
a biasing member for biasing said holder towards the lid of said bottle;
an actuating member for actuating said holder in a direction away from said lid to extract said needle from said pierced hole for opening said bottle; and
a housing for accommodating said bottle and the holder therein; said housing including a gas duct for forwarding said compressed gas, ejected via said pierced hole in said lid, to outside.

2. The gas ejection device according to claim 1 further comprising:
a control member for compressing against the opposite end of said holder for controlling the movement of said bottle in a direction away from said lid; said control member controlling the opening/closure of said bottle by said actuating member for controlling the amount of ejection of said compressed gas.

3. The gas ejection device according to claim 1 wherein said pierced hole is formed by said needle pierced through said lid.

4. The gas ejection device according to claim 1 wherein an ejection nozzle for ejecting said compressed gas is formed in said gas duct.

5. The gas ejection device according to claim 1 wherein said biasing member is a torsion coil spring having one end compressing against said holder;
there being formed in said housing a top plate for carrying the other end of said torsion coil spring.

6. The gas ejection device according to claim 1 wherein said actuating member includes an operating lever having one end, with a pivot at a point along the longitudinal direction as a boundary, compressing against said holder for causing movement of said holder in a direction away from said lid for opening said bottle, to open said bottle, and a thrusting member engaged with the opposite end of said operating lever, with said pivot as a boundary, said thrusting member being thrust for causing said operating lever to be rotated in a direction in which said holder is moved away from said lid; and wherein
a cap member is provided in said housing; said cap member carrying a thrust button for thrusting said thrusting member.

7. A spraying device comprising:
a gas bottle cartridge; said gas bottle cartridge including a bottle having an opening part sealed by a lid, said bottle being charged with a compressed gas in advance, a needle passed through a pierced hole formed in said lid for stopping up said lid, a holder holding said needle at one end thereof in a facing relation to said lid of said bottle and movable towards and away from said lid, a biasing member for biasing said holder towards the lid of said bottle, an actuating member for actuating said holder in a direction away from said lid for opening said bottle, and a housing for accommodating said bottle and the holder therein, said housing including a mating coupling part formed with a gas duct for forwarding said compressed gas, ejected via said pierced hole in said lid, to outside; and
a liquid tank; said liquid tank including a tank part charged with liquid, a liquid tube for forwarding the liquid charged in said tank part to outside said tank part, a coupling part for being coupled to said mating coupling part in said housing for coupling detachably to said gas cartridge bottle, and a nozzle member passed through said coupling part so that a distal end thereof faces the vicinity of an ejection port of said liquid tube;
said liquid being ejected in a mist along with said compressed gas.

8. The spraying device according to claim 7 wherein said biasing member is a torsion coil spring having one end compressing against said holder;
said housing including a top plate for supporting the opposite end of said torsion coil spring.

9. The spraying device according to claim 7 wherein said actuating member includes an operating lever having one end, with a pivot at a point along the longitudinal direction as a boundary, compressing against said holder for causing movement of said holder in a direction away from said lid for opening said bottle, to open said bottle, and a thrusting member engaged with the opposite end of said operating lever, with said pivot as a boundary, said thrusting member being thrust for causing said operating lever to be rotated in a direction in which said holder is moved away from said lid; and wherein
a button casing is provided in said housing; said cap member carrying a thrust button for thrusting said thrusting member.

10. The spraying device according to claim 7 wherein said pierced hole is formed by said needle pierced through said lid.

11. The spraying device according to claim 7 further comprising:
a control member for compressing against the opposite end of said holder for controlling the movement of said bottle in a direction away from said lid; said control member controlling the opening/closure of said bottle by said actuating member for controlling the amount of ejection of said compressed gas.

12. The spraying device according to claim 7 wherein
said ejection port of said liquid tube faces the upper surface section of said tank part with offset along the direction of ejection of said nozzle member.

13. A spraying device comprising:
a tank part charged with a liquid in advance;
a liquid tube for forwarding the liquid charged into said tank part to outside said tank part;
an ejection part communicating with said liquid tube for discharging the liquid flowing in said liquid tube;
a bottle having an opening part sealed by a lid and charged in advance with a compressed gas;
a needle piercing through a pierced hole formed in said lid for stopping said pierced hole;
a holder for holding said needle in a facing relation to said lid of said bottle for movement towards and away from said lid;
a biasing member for biasing said holder towards said lid of said bottle;
an actuating member for actuating said holder in a direction away from said lid for opening said bottle; and
an enclosure including a gas duct for said compressed gas having an ejection port of said compressed gas, ejected from said pierced hole in said bottle, said ejection port facing the vicinity of said ejection part of said liquid, said enclosure housing said bottle and the holder;
said liquid being ejected in a mist along with said compressed gas.

14. The spraying device according to claim 13 wherein said biasing member is a torsion coil spring having one end compressing against said holder;
said housing including therein a top plate supporting the opposite end of said torsion coil spring.

15. The spraying device according to claim 13 wherein said actuating member includes an operating lever having one end, with a pivot at a point along the longitudinal direction as a boundary, compressing against said holder for causing movement of said holder in a direction away from said lid for opening said bottle, to open said bottle, and a thrusting member engaged with the opposite end of said operating lever, with said pivot as a boundary, said thrusting member being thrust for causing said operating lever to be rotated in a direction in which said holder is moved away from said lid; and wherein
a button casing is provided in said housing; said cap member carrying a thrust button for thrusting said thrusting member.

16. The spraying device according to claim 13 wherein said pierced hole is formed by said needle pierced through said lid.

17. The spraying device according to claim 13 further comprising
a control member for compressing against the opposite end of said holder for controlling the movement of said bottle in a direction away from said lid; said control member controlling the opening/closure of said bottle by said actuating member for controlling the amount of ejection of said compressed gas.

18. The spraying device according to claim 13 wherein
said ejection port of said liquid tube faces the upper surface section of said tank part with offset along the direction of ejection of said nozzle member.
